(19) United States
(12) Patent Application Publication
(10) Pub. No.: US 2026/0022206 A1
(43) Pub. Date: Jan. 22, 2026

(54) CARBOXY-TERMINATED POLYCARBONATE, AND PREPARATION METHOD

(71) Applicant: Covestro Deutschland AG, Leverkusen (DE)

(72) Inventors: Andreas Seidel, Dormagen (DE); Marina Reithmeier, Köln (DE); Jan Heijl, Evergem (BE)

(21) Appl. No.: 18/993,631

(22) PCT Filed: Jul. 18, 2023
(86) PCT No.: PCT/EP2023/069858

§ 371 Date: Jan. 13, 2025

(30) Foreign Application Priority Data
Jul. 25, 2022 (EP) 22186639.5

(51) Int. Cl. C08G 64/14; C08G 64/42; C08G 81/02

(52) U.S. Cl. CPC C08G 64/14; C08G 64/42; C08G 81/027

(57) ABSTRACT

The invention relates to a polycarbonate containing structural units derived from bisphenol A and A) structural units that are derived from a hydroxybenzoic acid, are present as end groups, and have free COOH functionality and B) structural units that are optionally derived from a hydroxybenzoic acid, wherein component B) is selected from at least one representative from B1) structural units that are derived from a hydroxybenzoic acid, are present as end groups, and have esterified COOH functionality, and B2) structural units that are derived from a hydroxybenzoic acid and are incorporated into the polymer chain via an ester or acid anhydride group, wherein the content of free bisphenol A in the polycarbonate is at most 50 ppm and wherein, if component B is present, the ratio of the molar amount of component B1 to the sum of the molar amounts of components A and B is at most 0.07. The invention also relates to: a method for preparing such a polycarbonate; the use of such a polycarbonate in a method for preparing copolymers or thermoplastic compositions containing copolymers; a copolymer containing structural units derived from the polycarbonate; a thermoplastic (moulding) composition; and a moulded body containing the polycarbonate and/or the copolymer.

The present invention relates to a polycarbonate containing structural units derived from bisphenol A and structural units having a free COOH functionality derived from a hydroxybenzoic acid and present as end groups which features a thermally stable low content of free bisphenol A, to a process for producing such a polycarbonate, to the use of the polycarbonate in a process for producing copolymers, to a copolymer containing structural units derived from the polycarbonate according to the invention, to a thermoplastic (molding) compound containing the polycarbonate according to the invention and/or the copolymer according to the invention and to a shaped article containing the polycarbonate according to the invention, the copolymer according to the invention and/or the (molding) compound according to the invention.

“Containing structural units derived from bisphenol A” is to be understood as meaning that bisphenol A is present covalently integrated into the polymer chain via the hydroxy groups, wherein the chemical incorporation is carried out via a condensation reaction of the hydroxy groups of the bisphenol A with a carbonic acid derivative to form a carbonate functionality. In analogous fashion “containing structural units derived from a hydroxybenzoic acid and present as end groups” is to be understood as meaning that the hydroxybenzoic acid is present covalently incorporated at the end of the polymer chain via the hydroxy group, wherein the chemical incorporation is carried out via a condensation reaction of the hydroxy group of the hydroxybenzoic acid with a carbonic acid derivative to form a carbonate functionality.

Polycarbonate, especially polycarbonate based on bisphenol A, has been used for many years for producing transparent or translucent (transilluminable) shaped articles. The automotive sector, the construction sector and the electronics sector have in recent years gained applications with novel illumination concepts and function integration which employ transilluminable molding compounds.

However, for some applications polycarbonate is inadequate in terms of important properties such as for example scratch resistance, stress cracking resistance under the influence of chemicals, mechanical properties and processing characteristics (melt flowability). The development of polymer blends of polycarbonate with other thermoplastics is an often used approach to realize specific technical demand profiles through combination of the specific advantageous properties of polycarbonate with those of the polymeric blend partners, ideally in a synergistic fashion. Polymer blends of polycarbonate (PC) and polymethyl methacrylate (PMMA) may for example exhibit improvements over pure polycarbonate in terms of scratch resistance, stress cracking resistance under the influence of chemicals and melt flowability. Material ductility may simultaneously be increased relative to polymethyl methacrylate.

However, the advantageous combinations of properties which can be achieved with such polymer blends often preclude a transparency/transilluminability of shaped articles produced therefrom. Polycarbonate and the further thermoplastic present in the polymer blend are generally incompletely miscible and therefore form biphasic morphologies with a matrix phase of one polymer and domains of the other polymers distributed therein. Due to the typically different refraction indices of the blend partners light scattering occurs at the multiplicity of phase interfaces and light transmittance is thus altogether considerably reduced compared to that of the pure blend components. Such blends of polycarbonate and polycarbonate-immiscible polymers are thus generally opaque, i.e. not transilluminable or transilluminable only with an inadequate light yield.

The phase interfaces may moreover constitute mechanical weak points and, especially under the influence of chemicals, lead to material failure.

One option described in the literature for achieving improved compatibility of polycarbonate with a PC-immiscible thermoplastic blend partner such as for example PMMA is in situ formation of block copolymers from polycarbonate and the polymeric blend partner, i.e. in this specific case PMMA, in a reactive extrusion. The chemical reaction of the two polymers at the phase interface of the biphasic melt mixture may be accelerated through the use of a catalyst.

WO 2020/212229 A1 discloses a reactive compounding process for producing a thermoplastic molding compound using aromatic polycarbonate containing no reactive functional groups and a further polymer which contains at least one type of functional groups selected from ester, epoxy, hydroxy, carboxy and carboxylic anhydride groups, wherein the catalyst employed is a special phosphonium salt. The application especially also discloses the production of transparent thermoplastic PC/PMMA molding compounds in such a process.

WO 2016/138246 A1 discloses transparent PC/PMMA blends containing 9.9% to 40% by weight of polycarbonate and 59.9% to 90% by weight of PMMA which are produced from non-reactively functionalized polymer components in a reactive melt extrusion using 0.0025 to 0.1% by weight of a tin catalyst.

WO 2016/189494 A1 discloses transparent PC/PMMA blends containing 80% to 95% by weight of a specifically specified branched polycarbonate having an end cap content of 45% to 80% and 4.9% to 20% by weight of PMMA which are produced in a melt extrusion by transesterification using 0.1% to 1.5% by weight of a catalyst, preferably selected from Zn, Sn and Ag compounds.

Molded parts made of blend compositions produced by these processes are improved in terms of light transmittance relative to molded parts made of PC/PMMA compositions produced by purely physical mixing processes but generally have a light yield upon transillumination which is not yet adequate for many applications and inadequate mechanical properties.

In addition to the described use of a catalyst a suitable functionalization of the polycarbonate can likewise favor the in situ formation of copolymers.

U.S. Pat. Nos. 4,853,458 and 4,959,411 describe the production of terminally carboxy-functionalized polycarbonates, wherein a carboxylic acid- or carboxylic acid derivative-substituted phenol, preferably t-butyl p-hydroxybenzoate, is terminally incorporated into the PC as chain terminator in a polycarbonate-forming reaction. Also disclosed is a process for producing a block copolymer by reaction in organic solution or in a melt compounding of an epoxy-functionalized olefin polymer with such a carboxy- or carboxylic acid derivative-functionalized polycarbonate and to the use of such a copolymer for compatibilizing polymer blends of polycarbonate and polyolefin with the objective of reducing their tendency to delamination. These applications give no pointers to the suitability of polycarbonates functionalized in this way for producing transparent PC/PMMA blends.

For the latter approach of a reaction between a suitably functionalized polycarbonate and a suitably functionalized polymeric blend partner as a process for producing a block copolymer the precise type of functionalization of the polycarbonate, i.e. the selection and concentration of suitable reactive groups, is of great importance in terms of the success of a process for producing the block copolymer in a quality required for the desired application. In terms of the reactivity and selectivity of the reaction with epoxy-functionalized polymers it has proven particularly advantageous in the production of block copolymers in a melt compounding to use carboxy-functionalized polycarbonates, such as are described in U.S. Pat. Nos. 4,853,458 and 4,959,411.

An essential quality feature for the desired applications is a lowest possible residual content of undesired components that are removable again only incompletely, if at all, in the process of the downstream block copolymer production. Against the backdrop of global regulation of free bisphenol A in polymers, compositions and articles, a particular objective is that of keeping the content of free bisphenol A in such functionalized polycarbonates containing structural units derived from bisphenol A as low as possible. This objective is driven by the environmental policy objective of minimizing the release of bisphenol A into the environment in the context of the use of such products in their life cycle. Against the backdrop of the present restrictions in the European Union under the REACH Regulation it is desirable to achieve a value in the range <50 ppmw, preferably <20 ppmw, particularly preferably <10 ppmw in polymers, compositions and articles.

Bisphenol A itself has a negligible volatility at the temperatures of the workup and/or further processing of the polycarbonates according to the invention through a melt degassing for example, in the production of the copolymers from such polycarbonates in a coupling reaction in the melt and in the production of thermoplastic molding compounds containing such polycarbonates or copolymers by compounding or in the further thermal forming thereof. Free bisphenol A, which the polycarbonate contains as a consequence of its production, thus can no longer be effectively eliminated from the product in these downstream processing steps.

Such thermal processing steps downstream of the production of the carboxy-terminated polycarbonate generally even form further free bisphenol A from the polymer chain by retrocleavage, thus further increasing the content thereof in the final product to be marketed.

It was accordingly desirable to provide a carboxy-terminated polycarbonate and a process for producing a preferably carboxy-terminated polycarbonate, wherein the (preferably carboxy-terminated) polycarbonate has an improved stability toward formation of free bisphenol A by retrocleavage under thermal stress, for example during its processing in a melt degassing, in a use for producing a block copolymer in a melt reaction in the context of a reactive extrusion (also referred to as melt compounding in the context of the present invention), in the production of a thermoplastic molding compound containing such a polycarbonate or such a block copolymer in a melt compounding and/or in the thermal forming of such a polycarbonate, such a block copolymer or a thermoplastic composition containing such a polycarbonate or such a block copolymer.

It was further desirable to improve the quality of the carboxy-terminated polycarbonates such that they are more suitable for production of block copolymers or for production of such block copolymers containing polymer molding compounds having improved technical properties, wherein the production of the block copolymers or the polymer molding compounds containing these block copolymers is carried out in the melt mixture in a reactive extrusion, synonymously also referred to below as melt compounding in this context, with an epoxy-functionalized polymer distinct from polycarbonate.

A desirable technical improvement of the block copolymers produced by melt compounding from the carboxy-terminated polycarbonate or of the polymer molding compounds containing these block copolymers produced from the carboxy-terminated polycarbonate by melt compounding may manifest, for example, in better properties of the block copolymers or of the polymer molding compounds containing these block copolymers themselves (for example improved mechanical properties, scratch resistance, chemicals resistance, elevated light transmittance (transparency), improved color neutrality having regard to color coordinates and/or thermal stability thereof and/or reduced content of free bisphenol A or improved thermal stability of the content of free bisphenol A in further thermal processing steps such as for example the compounding of compositions containing the copolymers and/or the shaping of the copolymers or the thermoplastic molding compounds containing such copolymers).

An alternative desirable technical improvement of the block copolymers produced by melt compounding from the carboxy-terminated polycarbonate or the polymer molding compounds containing these block copolymers produced from the carboxy-terminated polycarbonate by melt compounding may manifest in their higher efficacy as a compatibilizer in polymer blends or their higher efficacy as a functional additive in polymer molding compounds, in particular in polycarbonate molding compounds.

The carboxy-terminated polycarbonates produced in a production process according to U.S. Pat. Nos. 4,853,458 and 4,959,411 satisfy the above-described objectives only inadequately.

In the process disclosed in these documents the terminal carboxy functions in the polycarbonate are released by thermal end-group pyrolysis of a polycarbonate containing as end groups structural units derived from a carboxylic acid derivative-substituted phenol, preferably from a carboxylic ester-substituted phenol, particularly preferably from tert-butyl-p-hydroxybenzoate. However, in this thermal end group pyrolysis the carboxy end groups formed may react to a not inconsiderable extent, especially at high temperatures, with carbonate functions in the polymer chain in a transesterification while at relatively low temperatures the end group pyrolysis generally proceeds incompletely, if at all. Accordingly, the possible processes for producing the carboxy-terminated polycarbonates according to the prior art are limited to a very narrow process window which is technically difficult to realize in a controlled fashion.

It was thus also desirable—not least because it is desirable to realize a process which is as energy-efficient as possible—to provide a process for producing the carboxy-terminated polycarbonates where the end group pyrolysis already proceeds completely at reduced temperatures in order thus to increase the distance from the maximum allowed process temperature above which the undesired transesterification occurs to an appreciable extent and thus to increase the width of the processing window allowed in this low temperature regime.

It was further also desirable to provide a process for producing the carboxy-terminated polycarbonates where higher temperatures are also allowed in the end group pyrolysis without the terminal carboxy groups initially produced by end group pyrolysis reacting again in the same process step in an undesired subsequent reaction (for example a transesterification) to an appreciable extent or even completely. It would further be desirable if the produced polycarbonate could be sent to a workup according to technically customary processes, for example a melt degassing which in polycarbonates is typically carried out at temperatures >280° C., often also >300° C. or even >320° C. without the carboxy groups reacting to an appreciable extent or even completely in an undesired subsequent reaction.

Transparent shaped articles or translucent shaped articles which are to be transilluminated in their application are generally subject to high demands in terms of intrinsic color and consistency thereof, i.e. independence from, for example, the exact conditions of production and/or the quality of the raw materials used for their production. A high and wavelength-independent light transmittance over the entire wavelength spectrum of visible light, which results in a color-neutral (i.e. substantially colorless) appearance, is often required for such shaped articles. It was thus preferably also desirable to provide carboxy-terminated polycarbonates which meet the aforementioned requirements and feature an improved raw hue and/or an improved stability of this raw hue under thermal stress, i.e. preferably ideally irrespective of their thermal history exhibit a high and largely wavelength-independent light transmittance over the entire wavelength spectrum of visible light, thus resulting in an ideally color-neutral (i.e. substantially colorless) appearance.

It was thus desirable to provide a polycarbonate containing in the polymer chain, hereinbelow also referred to synonymously as the polymer backbone, structural units derived from bisphenol A and structural units having a free COOH functionality derived from a hydroxybenzoic acid and present as end groups having a low content of free bisphenol A after thermal stress and preferably having an ideally color-neutral appearance, more preferably ideally having a thermally stable color-neutral appearance, and a process for the production thereof, wherein the polycarbonate is preferably better suited for the production of technically improved copolymers and/or technically improved molding compounds containing copolymers and/or of thermoplastic molding compounds containing the polycarbonate or respective articles produced therefrom each having a preferably likewise low content of free bisphenol A, wherein the copolymers contain at least one polycarbonate block having structural units derived from bisphenol A.

It was especially desirable to provide such a polycarbonate that is particularly suitable for the production of thermoplastic molding compounds containing polycarbonate and a vinyl (co)polymer, preferably polymethyl methacrylate, wherein these thermoplastic molding compounds are suitable for producing transilluminable shaped articles, i.e. have a high transparency.

It was likewise desirable to provide a process which makes it possible to produce a carboxy-functionalized polycarbonate having a high content of COOH end groups in a manner which is simpler and more stable from a process engineering standpoint (i.e. over a wider process parameter window with less off-spec waste and/or more infrequent process interruptions), more cost-effective and/or more energy-efficient.

It has now surprisingly been found that a polycarbonate containing structural units derived from bisphenol A and
A) structural units having a free COOH functionality derived from a hydroxybenzoic acid and present as end groups and
B) optionally structural units derived from a hydroxybenzoic acid,
   wherein component B) is selected from at least one representative of
   B1) structural units having an esterified COOH functionality derived from a hydroxybenzoic acid and present as end groups
   and
   B2) structural units derived from a hydroxybenzoic acid which are incorporated in the polymer chain via an ester or acid anhydride group,
   wherein the content of free bisphenol A in the polycarbonate is not more than 50 ppm, preferably not more than 20 ppm, particularly preferably not more than 10 ppm and
   wherein in the case that component B is present the ratio of the molar amount of component B1 to the sum of the molar amounts of components A and B is not more than 0.07, preferably not more than 0.05, more preferably not more than 0.02, particularly preferably not more than 0.01,
has at least one of the desired properties.

Preferred polycarbonates according to the invention have the feature that they contain component B.

Further preferred polycarbonates according to the invention have the feature that they contain component B2 and the ratio of the molar amount of component B2 to the sum of the molar amounts of components A and B2 is 0.001 to 0.25.

The polycarbonates according to the invention preferably have the feature that the ratio of the molar amount of component B2 to the sum of the molar amounts of components A and B2 is not more than 0.12, preferably not more than 0.10, particularly preferably not more than 0.08, most preferably not more than 0.03.

Further preferred polycarbonates according to the invention have the feature that the ratio of the molar amount of component A to the molar amount of component B is at least 8, more preferably at least 10, particularly preferably at least 12, most preferably at least 25.

In a preferred embodiment the polycarbonates according to the invention may further optionally contain
C) structural units which are derived from at least one phenolic compound having only one phenolic OH functionality and containing no carboxy or carboxy derivative functionality and are present as end groups.

In the context of the present invention such phenolic compounds having only one phenolic OH functionality and containing no carboxy or carboxy derivative functionality are also referred to as monophenols containing no carboxy or carboxy derivative functionality.

Such polycarbonates according to the invention containing component C) contain said component in a molar proportion, based on a total of 100 mol % of the molar proportions of components A, B1, B2 and C, of preferably 50 to 90 mol %, more preferably 60 to 80 mol %, particularly preferably 65 to 75 mol %.

The aforementioned preferred ranges of the molar quantity ratios of A to B, of B2 to the sum of A and B2, of B1 to the sum of A and B and of C to the sum of A, B1, B2 and C may be combined with one another as desired.

Greatest preference is given to polycarbonates having the aforementioned features in which the ratio of the molar amount of component A to the molar amount of component B is at least 25, the ratio of the molar amount of component B2 to the sum of the molar amounts of components A and B2 is not more than 0.08 and the ratio of the molar amount of component B1 to the sum of the molar amounts of components A and B is not more than 0.01.

The molar amount of component B is calculated as the sum of the molar amounts of components B1 and B2.

Preferred polycarbonates according to the invention are characterized by an acid number in the range from 0.3 to 30 mg potassium hydroxide (KOH)/g, preferably in the range from 0.5 to 20 mg potassium hydroxide (KOH)/g, most preferably in the range from 1.0 to 10 mg potassium hydroxide (KOH)/g, in each case determined in dichloromethane (DCM)/ethanol as solvent according to DIN EN ISO 2114, method A, 2002-6 version, by potentiometric titration with ethanolic KOH solution at room temperature.

The present invention further provides a process for producing the polycarbonates according to the invention.

It has surprisingly been found that production of a polycarbonate (II) containing end groups having a free COOH functionality derived from at least one hydroxybenzoic acid may advantageously be carried out by a process, wherein
a polycarbonate (I) containing end groups derived from at least one hydroxybenzoic ester
is subjected in the presence of 0.01% to 0.30% by weight, preferably 0.02% to 0.15% by weight, particularly preferably 0.03% to 0.07% by weight, in each case based on the amount of polycarbonate (I), of phosphorous acid H₃PO₃
and with application of negative pressure for 10 s to 15 min, preferably for 20 s to 5 min,
to a temperature in the range from 240° C. to 360° C., preferably 250° C. to 300° C.,
   to form the polycarbonate (II).

In a preferred embodiment polycarbonate (I) and polycarbonate (II) contain structural units derived from bisphenol A.

In a preceding step the production of the polycarbonate (I) may be carried out by
phosgenation in the phase interface process or in organic solution of bisphenol A or a mixture of several structurally different diols containing bisphenol A in the presence of at least one ester of a hydroxybenzoic acid (preferably at least one ester of p-hydroxybenzoic acid) or in the presence of a mixture containing at least one ester of a hydroxybenzoic acid and at least one monophenol containing no carboxy or carboxy derivative functionality
as a chain terminator or chain terminator mixture
   wherein the at least one ester of a hydroxybenzoic acid is an ester of a hydroxybenzoic acid esterified with
   an alcohol of general structural formula (1)

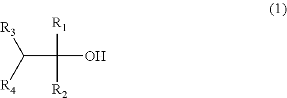

wherein R₁ and R₂ independently of one another represent hydrogen or an alkyl, aryl or alkylaryl radical having 1 to 10 carbon atoms, preferably hydrogen or an alkyl radical having 1 to 4 carbon atoms, particularly preferably hydrogen or a methyl radical, most preferably both represent a methyl radical, and
R₃ and R₄ independently of one another represent hydrogen or an alkyl, aryl or alkylaryl radical having 1 to 10 carbon atoms, preferably hydrogen or an alkyl radical having 1 to 4 carbon atoms, particularly preferably hydrogen or a methyl radical, most preferably both represent hydrogen.

After production of the polycarbonate (I) a workup may be carried out as a separate step before production of the polycarbonate (II),
wherein
solvents, preferably the solvents used in the process step in the production of the polycarbonate (I), are preferably removed down to a residual content of <0.1% by weight.

The workup of the polycarbonate (I) is preferably carried out by spray drying or by precipitation in a suitable solvent, for example and preferably in isopropanol, methanol or water, with subsequent separation of the solvent phase (mother liquor). This separation may be carried out for example by filtration or sedimentation with subsequent decanting, by centrifugation or a combination of these processes. This separation of the precipitated polycarbonate solid is in each case followed by a drying, wherein the drying is preferably carried out at temperatures in the range from 60° C. to 120° C., particularly preferably with application of negative pressure, and wherein one or more washing steps may optionally be carried out on the precipitated solid between the precipitation and the drying for the purpose of removing process-related impurities and/or monomers and/or oligomers from the product. During this workup process the polycarbonate (I) is at no point subjected to a temperature >200° C.

The phosphorous acid is preferably added in the process as an aqueous solution. It is preferable to produce a physical premixture from the polycarbonate (I) with the phosphorous acid or with the aqueous solution of the phosphorous acid. It is likewise preferable for the intermediate product thus produced to be dried at a temperature below 150° C. before heating to the temperature in the range from 240° C. to 360° C., preferably in the range from 250° C. to 300° C., i.e. before the heating to the temperature of the end group pyrolysis.

In a further specific embodiment the removal of the solvent used in the production of the polycarbonate (I) and the formation of polycarbonate (II) from polycarbonate (I) is effected simultaneously rather than successively. In this embodiment of the process according to the invention for producing the polycarbonate according to the invention the phosgenation is carried out as described above in the phase interface process or in organic solution of bisphenol A or a mixture of two or more structurally distinct diols containing bisphenol A in the presence of an ester of a hydroxybenzoic acid to form polycarbonate (I). The reaction product from this production which still contains solvent is then is subjected in the presence of 0.01% to 0.30% by weight, preferably 0.02% to 0.15% by weight, particularly preferably 0.03% to 0.07% by weight, based on the amount of polycarbonate (I), of phosphorous acid (H₃PO₃) and with application of negative pressure to a temperature in the range from 240° C. to 360° C., preferably in the range from 250° C. to 300° C., for a period of 10 s to 15 min, preferably of 20 s to 5 min so that in a single process step
a) the solvents are removed down to a residual content of preferably <0.1% by weight and
b) structural units having a free COOH functionality derived from a hydroxybenzoic acid and present in the polycarbonate as end groups, i.e. polycarbonate (II), are formed from the end groups derived from a hydroxybenzoic ester.

It is preferable when an alkene is eliminated in the production of the polycarbonate (II) from the polycarbonate (I).

The eliminated alkene generally has the general structural formula R₃R₄C═CR₁R₂, wherein R₁, R₂, R₃ and R₄ are as defined above and correspond to the respective radicals R₁, R₂, R₃ and R₄ in the alcohol with which the hydroxybenzoic esters used as chain terminators in the production of the polycarbonate (I) are esterified as a protecting group.

The production of polycarbonate (II) from polycarbonate (I) is preferably carried out in a process apparatus selected from the group comprising single-screw extruders, co-rotating or counter-rotating twin-screw extruders, planetary roller extruders, continuous or discontinuous internal kneaders, filmtruders, extruder evaporators and foam evaporators.

The product resulting from the production of the polycarbonate (II) is a melt of a carboxy-terminated polycarbonate having a content of residual solvent of preferably <0.1% by weight which in subsequent optional process steps is
a) cooled and thus solidified and further
b) optionally pelletized and/or
c) optionally ground into a powder.

The process product further contains at least a sub-amount of the phosphorous acid employed in the process and/or other phosphorus compounds formed therefrom under the conditions of the thermal treatment of the polycarbonate in the presence of the phosphorous acid in the process according to the invention. This may for example and preferably be phosphoric acid, salts of phosphorous acid, salts of phosphoric acid and condensates of phosphorous acid and/or phosphoric acid.

The present invention thus also relates to thermoplastic compounds containing a polycarbonate (II) according to the above-described features and preferred ranges and at least one phosphorus compound selected from the group consisting of phosphorous acid, phosphoric acid, salts of phosphorous acid and phosphoric acid and condensates of phosphorous acid and phosphoric acid, preferably selected from the group consisting of phosphorous acid and salts of phosphorous acid in each case in a total amount of 0.01% to 0.30% by weight, preferably 0.02% to 0.15% by weight, particularly preferably 0.03% to 0.07% by weight.

In the context of the present application the terms “carboxy” and “carboxyl” are used synonymously and represent COOH groups.

The polycarbonate according to the invention is hereinbelow also referred to as aromatic polycarbonate or as (aromatic) polycarbonate containing (terminal) COOH end groups.

As a result of their inventive features, in particular the specific ratios of A to B, of B2 to the sum of A and B2 and of B1 to the sum of A and B, and as a consequence of their low content of free bisphenol A, as was able to be realized for the first time by means of the process according to the invention the polycarbonates according to the invention are particularly suitable for the production of technical improved copolymers or of molding compounds containing such copolymers.

These copolymers or thermoplastic molding compounds containing such copolymers are obtainable in a process comprising the steps of
a) melting a composition containing
an inventive polycarbonate (II) according to the above-described features and preferred ranges, wherein component B is present, and
a further polymer containing at least one type of functional groups selected from ester, hydroxy and epoxy groups, preferably containing epoxy groups, more preferably a polyolefin or vinyl (co)polymer, particularly preferably polymethyl methacrylate containing glycidyl methacrylate-derived structural units which are grafted onto the vinyl (co)polymer or polyolefin or incorporated into the polymer chain (i.e. the polymer backbone) of the vinyl (co)polymer or polyolefin
through introduction of thermal energy and/or mechanical shear,
b) mixing and dispersing the different components of the composition with/into one another,
c) solidifying the melt by cooling,
d) pelletizing the solidified product resulting from steps (a) to (c),
wherein in the context of the process a chemical coupling reaction of the structural units having a free COOH functionality derived from a hydroxybenzoic acid and present as end groups in the polycarbonate (II) with the further polymer containing at least one type of functional groups selected from ester, hydroxy and epoxy groups, preferably containing epoxy groups is effected in the melt.

Step (b) of this process is preferably carried out in a compounding machine selected from the group consisting of single-screw extruders, co-rotating or counter-rotating twin-screw extruders, planetary roller extruders, internal kneaders or co-kneaders and likewise preferably at a temperature of the melt of 230° C. to 300° C.

In particular, it was surprisingly found that such copolymers or molding compounds containing such copolymers which were produced from the polycarbonates (II) according to the invention, wherein component B is present, in the above-described process according to the invention using a polymethacrylate randomly modified with a glycidyl methacrylate comonomer as the epoxy-containing polymer exhibit a higher light transmittance (transparency) than comparable copolymers or molding compounds containing copolymers produced on the basis of a comparable polycarbonate which was produced according to the process described in the prior art (i.e. without addition of H₃PO₃ in the end group pyrolysis step).

The inventive polycarbonates and copolymers or molding compounds containing such copolymers are thermoplastic and are suitable especially for use as an additive in thermoplastic polycarbonate compositions, preferably as a compatibilizer in thermoplastic polycarbonate blends.

Such inventive thermoplastic polycarbonate compositions and thermoplastic polycarbonate blends containing the inventive copolymers or polycarbonates (II) are suitable for production of shaped articles, for example by injection molding, for applications of any kind. Such thermoplastic polycarbonate compositions and thermoplastic polycarbonate blends containing the inventive polycarbonates and/or such inventive copolymers or molding compounds containing such copolymers are suitable especially for the production of transilluminable molded parts and articles.

### Polycarbonate

The polycarbonate according to the invention contains structural units derived from bisphenol A and
A) structural units having a free COOH functionality derived from a hydroxybenzoic acid and present as end groups (also referred to as COOH or synonymously carboxy or carboxyl end groups) and
B) optionally structural units derived from a hydroxybenzoic acid,
wherein component B) is selected from at least one representative of
B1) structural units having an esterified COOH functionality derived from a hydroxybenzoic acid and present as end groups
and
B2) structural units derived from a hydroxybenzoic acid which are incorporated in the polymer chain via an ester group (=B2-a) and/or acid anhydride group (=B2-b),
   wherein the content of free bisphenol A in the polycarbonate is not more than 50 ppm, preferably not more than 20 ppm, particularly preferably not more than 10 ppm and
   wherein in the case that component B is present the ratio of the molar amount of component B1 to the sum of the molar amounts of components A and B is not more than 0.07, preferably not more than 0.05, more preferably not more than 0.02, particularly preferably not more than 0.01.

When calculating the ratio of the molar amounts of components A and B the employed molar amount of component B is the sum of the molar amounts of components B1, B2-a and B2-b. When calculating the ratio of the molar amounts of components B2 to the sum of the molar amounts of components A and B2 the employed molar amount of component B2 is the sum of the molar amounts of B2-a and B2-b.

The polycarbonates according to the invention preferably have an acid number of at least 0.3 mg potassium hydroxide (KOH)/g, more preferably at least 0.5 mg potassium hydroxide (KOH)/g, most preferably at least 1.0 mg KOH/g, in each case determined in dichloromethane (DCM)/ethanol as solvent according to DIN EN ISO 2114, method A, 2002-6 version, by potentiometric titration with ethanolic KOH solution at room temperature.

The polycarbonates according to the invention preferably have an acid number in the range from 0.3 to 30 mg potassium hydroxide (KOH)/g, particularly preferably in the range from 0.5 to 20 mg potassium hydroxide (KOH)/g, most preferably in the range from 1.0 to 10 mg potassium hydroxide (KOH)/g, in each case determined in dichloromethane (DCM)/ethanol as solvent according to DIN EN ISO 2114, method A, 2002-6 version, by potentiometric titration with ethanolic KOH solution at room temperature.

For determination of the acid number the polymer to be investigated is dissolved in a concentration of 10 g/L in 50 mL of dichloromethane at room temperature. 5 mL of ethanol are added to the sample solution before the potentiometric titration with 0.1 N ethanolic KOH.

Contemplated hydroxybenzoic acids include hydroxybenzoic acids having the carboxylic acid group para, meta or ortho to the phenolic OH group. Hydroxybenzoic acids having the carboxylic acid group para to the phenolic OH group are preferred. These may be mono- or polysubstituted at the free aromatic ring positions with C₁-C₁₀ alkyl, aryl or alkylaryl radicals, preferably with C₁-C₄ alkyl radicals, particularly preferably with methyl, or alternatively with halogen or ether groups, for example and preferably with methoxy.

The structural units derived from a hydroxybenzoic acid are particularly preferably structural units derived from p-hydroxybenzoic acid containing no further substituents.

The structural units having an esterified COOH functionality derived from a hydroxybenzoic acid and present as end groups according to component B1 are preferably esters of a hydroxybenzoic acid (preferably p-hydroxybenzoic acid), more preferably esterified with an alcohol of the abovementioned structural formula (1).

The alcohol is preferably a tertiary alcohol, most preferably tert-butanol.

The structures for the components A, B1 and B2 are represented by way of example in the formulae (2), (3), (4a) and (4b) for the p-hydroxybenzoic acid particularly preferred as the hydroxybenzoic acid, wherein formula (2) represents component A, formula (3) represents component B1 (for the example of the particularly preferred tert-butyl ester) and formulae (4a) and (4b) represent component B2. Formula (4a) shows the structural unit derived from a hydroxybenzoic acid which is incorporated in the polymer chain via an ester group (component B2-a). Formula (4b) shows the structural unit derived from a hydroxybenzoic acid which is incorporated in the polymer chain via an acid anhydride group (component B2-b). All structures contain structural units derived from bisphenol A.

In the formulae (2), (3), (4a) and (4b) m and n each represent the number of the monomer units shown in the brackets.

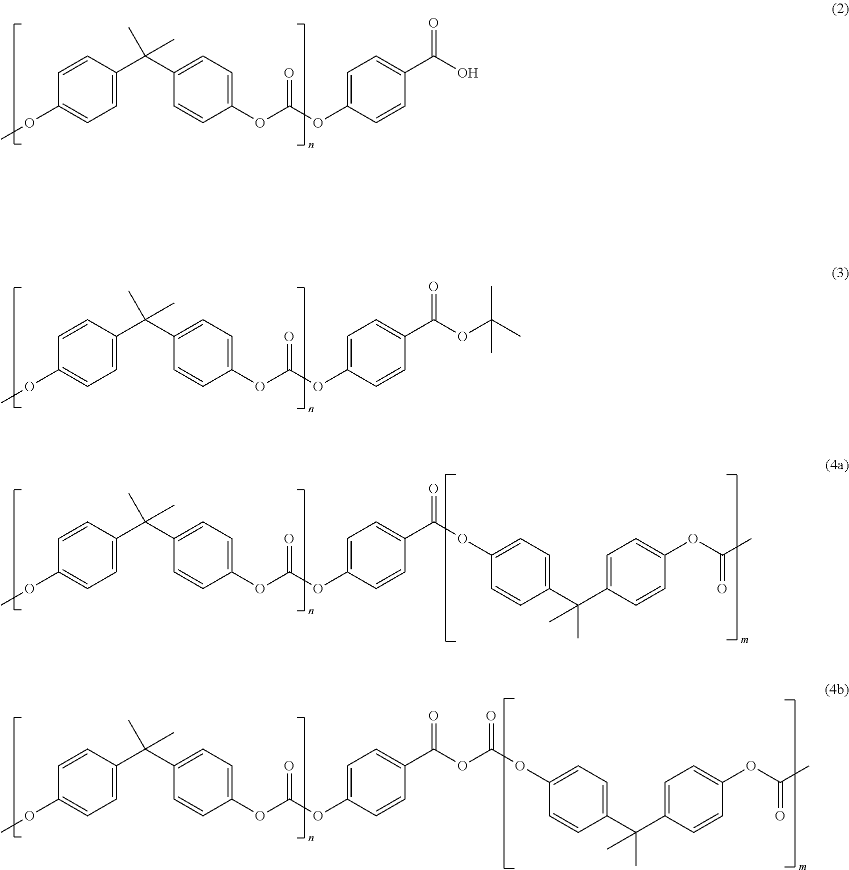

The molar proportion of components A and B1 and of the two possible structures for component B2, and the corresponding molar ratios of these components relevant for the invention are determined by ¹H NMR spectroscopy. To this end the polycarbonate is dissolved in deuterated chloroform at room temperature. The different structural units derived from a hydroxybenzoic acid may be distinguished via the NMR signals of the aromatic protons ortho to the carboxy functionality/to the derivatized carboxy functionality and the molar amounts/ratios of the different structures may be quantified on the basis of the integrated intensities of these signals. In the case of the particularly preferred p-hydroxybenzoic acid the spin-spin coupling of the ortho aromatic protons with the aromatic protons meta to the carboxy functionality/to the derivatized carboxy functionality means that doublets are concerned in all cases. For all components A, B1 and B2 the corresponding NMR signals are each attributable to two protons and therefore the ratios of the intensities of the corresponding NMR signals allow direct derivation of the corresponding ratio of the molar proportions of the different components in the polycarbonate.

In the special case of the particularly preferred p-hydroxybenzoic acid
the protons in the structural units derived from p-hydroxybenzoic acid according to component A resonate in the range of around 8.14 ppm,
the protons in the structural units derived from p-hydroxybenzoic acid according to component B1 in the case of the tert-butyl ester according to formula (2) resonate in the range of around 8.05 ppm,
the protons in the structural units derived from p-hydroxybenzoic acid according to component B2-b (formula 4b) which are incorporated in the polymer chain via an acid anhydride group resonate in the range of around 8.22 ppm and
the protons in the structural units derived from p-hydroxybenzoic acid according to component B2-a (formula 4a) which are incorporated in the polymer chain via an ester group resonate in the range of around 8.26 ppm,
wherein all chemical shifts are reported in “parts per million” (ppm) relative to trimethylsilane (TMS) as the reference.

Accordingly, preferred polycarbonates, in which the hydroxybenzoic acid-derived structural units according to components A, B1 and B2 are in all cases p-hydroxybenzoic acid-derived structural units and the structural units having an esterified COOH functionality derived from a hydroxybenzoic acid and present as end groups according to component B1 are structural units derived from tert-butyl 4-hydroxybenzoate according to formula (2), have the feature that in their ¹H NMR spectrum measured in a solution of the polycarbonate in deuterated chloroform at room temperature the ratio of the integrated intensity of the doublet signal in the range of around 8.05 ppm to the sum of the integrated intensities of the doublet signals in the ranges of around 8.14 ppm, around 8.05 ppm, around 8.22 ppm and around 8.26 ppm is at most 0.07, preferably at most 0.05, particularly preferably at most 0.02, most preferably at most 0.01, wherein the chemical shifts are in each case referenced against tetramethylsilane (TMS).

The polycarbonates according to the invention further have the feature that the ratio of the integrated intensity of the ¹H NMR doublet signal in the range around 8.14 ppm to the sum of the integrated intensities of the doublet signals in the ranges of around 8.05 ppm, 8.22 ppm and 8.26 ppm is preferably at least 8, particularly preferably at least 10, more preferably at least 12, most preferably at least 25, wherein the chemical shifts are in each case referenced against tetramethylsilane (TMS).

These polycarbonates according to the invention preferably also have the additional feature that in their ¹H NMR spectrum measured in a solution of the polycarbonate in deuterated chloroform at room temperature the ratio of the sum of the integrated intensities of the doublet signals in the ranges of around 8.22 ppm and 8.26 ppm to the sum of the integrated intensities of the doublet signals in the ranges of around 8.14 ppm, 8.22 ppm and 8.26 ppm is preferably at most 0.12, more preferably at most 0.10, particularly preferably at most 0.08 and most preferably at most 0.03, wherein the chemical shifts are in each case referenced against tetramethylsilane (TMS).

In a preferred embodiment the polycarbonate further contains as component C structural units derived from monophenols containing no carboxy or carboxy derivative functionalities as end groups. The monophenols containing no carboxy or carboxy derivative functionalities from which component C is derived are preferably phenol or phenols mono- or polysubstituted with alkyl, aryl, alkylaryl and/or halogen, particularly preferably phenol or C₁- to C₁₂-alkylphenols, more preferably phenol or p-tert-butylphenol, most preferably p-tert-butylphenol.

It is further possible to employ for example p-chlorophenol, 2,4,6-tribromophenol, 4-(2,4,4-trimethylpentyl)phenol, 4-(1,1,3,3-tetramethylbutyl)phenol, 3,5-di-tert-butylphenol, p-isooctylphenol, p-tert-octylphenol, p-dodecylphenol and 4-(3,6-dimethyl-3-heptyl)phenol.

In a preferred embodiment the monophenols mentioned here containing no carboxy or carboxy derivative functionalities are employed as further chain terminators in the production of the polycarbonates according to the invention.

It is also possible to employ mixtures of two or more monophenols containing no carboxy or carboxy derivative functionalities as chain terminators.

It is further preferable when component C is present in the polycarbonate according to the invention in a molar proportion, based on a total of 100 mol % of the molar proportions of components A, B1, B2, i.e. the sum of the molar proportions of B2-a and B2-b, and C, of 50 to 90 mol %, particularly preferably 60 to 80 mol %, most preferably 65 to 75 mol %. In the use of the polycarbonates according to the invention for producing copolymers these proportions can realize a sufficiently high yield of copolymer formation while avoiding undesired crosslinking reactions as further elucidated again below.

Also the amount of component C in the polycarbonate and the molar proportion thereof based on a total of 100 mol % of the molar proportions of components A, B1, B2 and C may be spectroscopically quantified by ¹H NMR. In the particularly preferred case in which component C are structural units derived from p-tert-butylphenol the NMR signal of the three methyl groups in the tert-butyl radical in the structural units derived from p-tert-butylphenol and present as end groups is for example particularly suitable therefor. This is a singlet at a chemical shift in the range of around 1.32 ppm referenced against trimethylsilane which is assigned to nine protons.

The polycarbonates according to the invention may also contain
as component A a plurality of structural units having a free COOH functionality derived from structurally distinct hydroxybenzoic acids and present as end groups,
as component B1 a plurality of different structural units having an esterified COOH functionality and present as end groups which are distinguishable both in terms of the structural nature of the hydroxybenzoic acid and in terms of the structural nature of the tertiary alcohol employed to form the ester,
as component B2 a plurality of structural units derived from structurally distinct hydroxybenzoic acids which are incorporated in the polymer chain via an ester or acid anhydride group,
and/or
as component C a plurality of structural units derived from monophenols containing no carboxy or carboxy derivative functionalities as end groups.

It is then the case that for all quantity ratio ranges of these structural units recited in the present invention the molar amounts of the components A, B1, B2 and C used to calculate the corresponding ratios are in each case the sum of all molar amounts of the structurally distinct components A, B1, B2 and C.

The polycarbonates according to the invention preferably have a weight-average molecular weight M. of 5000 to 40 000 g/mol, more preferably of 7000 to 35 000 g/mol, particularly preferably of 10 000 bis 33 000 g/mol, measured by GPC (gel permeation chromatography) calibrated against bisphenol A polycarbonate standards using dichloromethane as solvent. Calibration is effected with linear polycarbonates (formed from bisphenol A and phosgene) of known molar mass distribution from PSS Polymer Standards Service GmbH, Germany, calibration by method 2301-0257502-09D (2009, German language) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of column material: 3 μm to 20 μm. Concentration of solutions: 0.2% by weight. Flow rate: 1.0 ml/min, temperature of solutions: 30° C. Use of UV and/or RI detection.

For the use of the polycarbonate according to the invention for producing copolymers, the polycarbonate according to the invention preferably has a weight-average molecular weight M_{w}, measured by GPC (gel permeation chromatography) at room temperature in methylene chloride using a BPA polycarbonate standard, of 5000 to 30 000 g/mol, more preferably of 7000 to 25 000 g/mol, particularly preferably of 10 000 to 20 000 g/mol.

For the use of the polycarbonate according to the invention as the molding compound for producing molded parts or as a constituent of a molding compound for producing molded parts, the polycarbonate according to the invention preferably has a weight-average molecular weight M_{w}, measured by GPC (gel permeation chromatography) at room temperature in methylene chloride using a BPA polycarbonate standard, of 18 000 to 40 000 g/mol, more preferably of 20 000 to 35 000 g/mol, particularly preferably of 24 000 to 33 000 g/mol.

When employing a mixture of two or more polycarbonates having different individual acid numbers, a different ratio of A/B, a different ratio of B2/(A+B2), a different ratio of B1/(A+B) and/or different individual weight-average molecular weights M_{w}, this mixture has an acid number, a ratio of A/B, a ratio of B2/(A+B2), a ratio of B1/(A+B) and a weight-average molecular weight M_{w} in one of the abovementioned (preferred) ranges.

The production of polycarbonates containing structural units derived from bisphenol A incorporated in them (in the context of the present invention synonymously also referred to as bisphenol A-based polycarbonate or aromatic polycarbonate) is generally known in the literature (for production of aromatic polycarbonates see, for example, Schnell, “Chemistry and Physics of Polycarbonates”, Interscience Publishers, 1964).

The production of the inventive polycarbonates containing terminal COOH groups is carried out in two steps. In a first step a polycarbonate containing structural units derived from bisphenol A and end groups derived from a hydroxybenzoic ester is provided. This polycarbonate is preferably produced in a similar manner to that described in U.S. Pat. No. 4,853,458 B by reacting bisphenol A or a bisphenol A-containing mixture of diphenols (aromatic diols) with phosgene according to the phase interface process using at least one ester of a hydroxybenzoic acid as described above or a mixture containing at least one ester of a hydroxybenzoic acid and at least one monophenol containing no carboxy or carboxy derivative functionality, as a monophenolic chain terminator or as a chain terminator mixture. If two or more structurally distinct hydroxybenzoic esters are used in the chain terminator mixture these esters may differ both in the nature of the hydroxybenzoic acid and in the nature of the alcohol employed to form the ester. A second step comprises liberating the terminal COOH groups (COOH functionality).

When monophenolic chain terminators containing no carboxy or carboxy derivative functionalities are employed in the chain terminator mixture, the produced aromatic polycarbonate contains not only the components A, B1 and B2 but also structural units derived from the monophenolic chain terminators, most preferably derived from p-tert-butylphenol, as component C.

When producing the polycarbonates according to the invention, the monophenolic chain terminators containing no carboxy or carboxy derivative functionalities are preferably employed in the chain terminator mixture consisting of these monophenolic chain terminators containing no carboxy or carboxy derivative functionalities and the esters of a hydroxybenzoic acid employed as chain terminator in a molar proportion, based on a total of 100 mol % of the molar proportions of components A, B1, B2 and C, of 50 to 90 mol %, preferably 60 to 80 mol %, particularly preferably 65 to 75 mol %. The resulting difference in each case to 100 mol % then corresponds to the proportion of the ester or the mixture of different esters of one or more hydroxybenzoic acids. This is therefore preferably 10 to 50 mol %, particularly preferably 20 to 40 mol %, most preferably 25 to 35 mol %, based on a total of 100 mol % of the molar proportions of components A, B1, B2 and C.

If the content of hydroxybenzoic esters employed in the chain terminator mixture is greater than the specified preferred ranges, the inventive use of the polycarbonates in a process for producing copolymers can result in undesired crosslinking reactions during reactive compounding with the blend partner with the result that the thermoplastic processability of the reactive mixture is no longer ensured. If the content of esters of a hydroxybenzoic acid employed in the chain terminator mixture is lower than the specified preferred ranges, the desired copolymer formation between the polycarbonate and the blend partner can no longer occur in a yield sufficient to achieve the desired technical effect.

The molecular weight of the thus-produced polycarbonates is specifically adjustable over wide ranges in a manner familiar to those skilled in the art through variation of the ratio of the monophenolic chain terminator to diphenols.

The content of COOH groups in the polycarbonate according to the invention and thus also its acid number can be specifically adjusted over wide ranges via the usage amount ratio in the chain terminator mixture of the hydroxybenzoic esters to the optionally employed monophenolic chain terminators containing no carboxy or carboxy derivative functionalities.

The terminal COOH groups (i.e. end groups derived from hydroxybenzoic acids) are liberated from the polycarbonates with end groups derived from hydroxybenzoic esters by thermal end group pyrolysis.

The process according to the invention for liberating the terminal COOH groups is the thermal end group pyrolysis in the presence of 0.01% to 0.30% by weight, preferably 0.02% to 0.15% by weight, particularly preferably 0.03% to 0.07% by weight of phosphorous acid H₃PO₃ based on the amount of the polycarbonate precursor (I) containing hydroxybenzoic ester-derived end groups and with application of negative pressure at a temperature in the range from 240° C. to 360° C., preferably in the range from 250° C. to 300° C., for a period of 10 s to 15 min, preferably of 20 s to 5 min.

Under these thermal conditions the polycarbonate backbone (i.e. the polycarbonate polymer chain) is not appreciably degenerated and undesired side reactions are minimized. Component C remains generally unaffected in the thermal end group pyrolysis.

In combination with bisphenol A (hereinafter also referred to as in addition to bisphenol A) further diphenols for producing the polycarbonates according to the invention preferably include aromatic diphenols of formula (5)

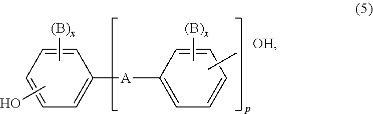

wherein
A is a single bond, C₁- to C₅-alkylene, C₂- to C₅-alkylidene, C₅- to C₆-cycloalkylidene, —O—, —SO—, —CO—, —S—, —SO₂—, C₆- to C₁₂-arylene, onto which further aromatic rings optionally containing heteroatoms may be fused,
   or a radical of formula (6) or (7)

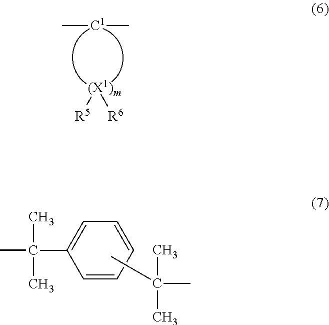

B is in each case C₁- to C₁₂-alkyl, preferably methyl, halogen, preferably chlorine and/or bromine,
x is in each case independently 0, 1 or 2,
p is 1 or 0, and
R⁵ and R⁶ are individually selectable for each X¹ and independently of one another hydrogen or C, to C₆ alkyl, preferably hydrogen, methyl or ethyl,
X¹ is carbon and
m is an integer from 4 to 7, preferably 4 or 5, with the proviso that, on at least one atom X¹, R⁵ and R⁶ are both alkyl.

Preferred diphenols in addition to bisphenol A include hydroquinone, resorcinol, dihydroxydiphenols, bis(hydroxyphenyl) C₁-C₅ alkanes, bis(hydroxyphenyl) C₅-C₆ cycloalkanes, bis(hydroxyphenyl) ethers, bis(hydroxyphenyl) sulfoxides, bis(hydroxyphenyl) ketones, bis(hydroxyphenyl) sulfones and α, α-bis(hydroxyphenyl)diisopropylbenzenes and also ring-brominated and/or ring-chlorinated derivatives thereof.

Particularly preferred diphenols in addition to bisphenol A include 4,4′-dihydroxydiphenyl, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenyl sulfide, 4,4′-dihydroxydiphenyl sulfone, and also the di- and tetrabrominated or chlorinated derivatives thereof, for example 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane.

If a bisphenol A-containing mixture of various representatives of the above-described diphenols is employed in the production of the polycarbonates according to the invention, this mixture contains bisphenol A in a usage amount, based on the sum of all employed diphenols, of at least 5 mol %, preferably at least 50 mol %, more preferably at least 75 mol %, especially preferably at least 90 mol %. Greatest preference is given to the use of pure bisphenol A as diphenol in polycarbonate production.

The diphenols employed in addition to bisphenol A may be used individually or as any desired mixtures. The diphenols are known from the literature or obtainable by processes known from the literature.

The polycarbonates according to the invention may be branched in known fashion and preferably through incorporation of 0.01 to 2.0 mol %, based on the sum of the employed diphenols, of trifunctional or more than trifunctional compounds, for example those having three or more phenolic groups.

It is preferable when the inventive polycarbonate containing COOH groups is a linear polycarbonate.

### Further Polymer for Producing a Copolymer

The inventive polycarbonate containing COOH end groups may be used for producing a copolymer or a copolymer-containing thermoplastic molding compound. The copolymer is preferably a block copolymer, more preferably a block copolymer comprising a vinyl (co)polymer or polyolefin.

Suitable polymers with which the inventive polycarbonate may form a copolymer comprise at least one type of functional groups selected from ester, hydroxy and epoxy groups. It is particularly preferable when the polymers contain epoxy groups.

In the case of an ester group as such a functional group this group may in the polymers be either a constituent of the polymer chain (polymer backbone), as is the case in a polyester, or a functional group of a monomer that is not directly involved in the growth of the polymer chain, as is the case for an acrylate polymer.

It is also possible to use mixtures of such polymers. The mixtures may in each case comprise polymers having identical functional groups or polymers having different functional groups.

It is preferable when the further polymer is selected from the aforementioned (preferred) functional group-containing vinyl (co)polymers, polyolefins and polyesters, more preferably vinyl (co)polymers and polyolefins and particularly preferably vinyl (co)polymers.

The functional group-containing vinyl (co)polymers according to the invention are preferably (co)polymers of at least one monomer from the group of (meth)acrylic acid (C₁ to C₈)-alkyl ester (for example methyl methacrylate, n-butyl acrylate, tert-butyl acrylate), unsaturated carboxylic acids and carboxylic anhydrides, vinylaromatics (for example styrene, α-methylstyrene), vinyl cyanides (unsaturated nitriles such as for example acrylonitrile and methacrylonitrile) and olefins (such as ethylene) with further vinyl monomers containing ester, hydroxy, carboxy, carboxylic anhydride or epoxy groups, preferably vinyl monomers containing epoxy groups, particularly preferably glycidyl methacrylate.

Epoxy groups are for example and preferably introduced when the further monomer glycidyl methacrylate is copolymerized together with the other monomer or the other monomers.

These (co)polymers are resin-like and rubber-free. (Co)polymers of this kind are known and can be produced by free-radical polymerization, especially by emulsion, suspension, solution or bulk polymerization.

Particularly suitable vinyl (co)polymers contain structural units derived from glycidyl methacrylate. A particularly suitable vinyl (co)polymer is a copolymer of methyl methacrylate and glycidyl methacrylate.

Particularly suitable vinyl (co)polymers further include styrene-acrylonitrile-glycidyl methacrylate terpolymers and styrene-methyl methacrylate-glycidyl methacrylate terpolymers.

The content of glycidyl methacrylate in the particularly suitable vinyl (co)polymers is preferably 0.5% to 10% by weight, more preferably 0.7% to 7% by weight, particularly preferably 1% to 5% by weight.

Suitable polyesters may be linear or branched. The polyesters are preferably linear. The polyesters may be aliphatic or aromatic. In a preferred embodiment the polyesters are aromatic, more preferably are polyalkylene terephthalates. In a particularly preferred embodiment, they are reaction products of aromatic dicarboxylic acids or reactive derivatives thereof, such as dimethyl esters or anhydrides, and aliphatic, cycloaliphatic or araliphatic diols and also mixtures of these reaction products.

Particularly preferred aromatic polyalkylene terephthalates contain at least 80% by weight, preferably at least 90% by weight, based on the dicarboxylic acid component, of terephthalic acid moieties and at least 80% by weight, preferably at least 90% by weight, based on the diol component, of ethylene glycol moieties and/or butane-1,4-diol moieties.

The preferably employed aromatic polyalkylene terephthalates have a viscosity number of 0.4 to 1.5 dl/g, preferably 0.5 to 1.2 d/g, measured in phenol/o-dichlorobenzene (1:1 parts by weight) at a concentration of 0.05 g/ml according to ISO 307 at 25° C. in an Ubbelohde viscometer.

The aromatic polyalkylene terephthalates can be produced by known methods (see for example Kunststoff-Handbuch [Plastics Handbook], volume VIII, p. 695 ff., Carl-Hanser-Verlag, Munich 1973).

It is likewise preferable when the further polymers are functional group-containing polyolefins, preferably epoxy-containing polyolefins, particularly preferably polyolefins containing structural units derived from glycidyl methacrylate.

Polyolefins are produced by chain polymerization, for example by free-radical or anionic polymerization. Monomers used are alkenes. An alternative name for alkenes is olefins. The monomers may be polymerized individually or as a mixture of various monomers. Preferred monomers are ethylene, propylene, 1-butene, isobutene, 1-pentene, 1-heptene, 1-octene and 4-methyl-1-pentene.

The polyolefins may be semicrystalline or amorphous and linear or branched. The production of polyolefins has long been known to those skilled in the art.

The polymerization may be carried out for example at pressures of from 1 to 3000 bar and temperatures between 20° C. and 300° C., optionally with use of a catalyst system. Examples of suitable catalysts include mixtures of titanium and aluminum compounds, and metallocenes.

The number of branchings, the crystallinity and the density of the polyolefins may be varied over wide ranges by modifying the monomer composition, the type of isomers used as monomer, the polymerization conditions and the catalyst system. These measures are also familiar to those skilled in the art.

Functional groups are for example introduced into the polyolefins through copolymerization, preferably by free-radical polymerization, of vinyl monomers containing the functional group with the olefin as described hereinabove. Suitable vinyl monomers are for example glycidyl methacrylate and methyl methacrylate.

An alternative mode of production is free-radical grafting of functional group-containing vinyl monomers, for example glycidyl methacrylate, onto a polyolefin.

The further polymers have average molecular weights (weight-average M_{w}, measured by GPC (gel permeation chromatography) against a polystyrene standard) of preferably 3000 to 300 000 g/mol, more preferably of 10 000 to 200 000 g/mol, particularly preferably of 20 000 to 100 000 g/mol.

The solvent for the GPC measurement is selected such that it is a good solvent for the further polymer, preferably at room temperature. If solubility in the selected solvent at room temperature is observed, the GPC is performed at room temperature.

Tetrahydrofuran for example is a suitable solvent for the preferred vinyl (co)polymers such as for example copolymers of methyl methacrylate and glycidyl methacrylate, styrene-acrylonitrile-glycidyl methacrylate terpolymers and styrene-methyl methacrylate-glycidyl methacrylate terpolymers. Suitable solvents for polyolefins containing structural units derived from glycidyl methacrylate include ortho-dichlorobenzene or 1,2-dichloroethane for example. Sufficient solubility is often brought about by an elevated temperature of for example 40° C., 60° C., 80° C., 100° C. or 120° C. In this case the GPC is performed at the temperature required for achieving a solubility sufficient for GPC. If the polyolefin requires a temperature above 40° C. to achieve a solubility sufficient for GPC it is preferable to employ ortho-dichlorobenzene as solvent.

Production of Copolymers and Molding Compounds Containing Copolymers from the Polycarbonates According to the Invention

Copolymers containing at least one polycarbonate block, preferably block copolymers with vinyl (co)polymers or polyolefins, most preferably block copolymers with PMMA, are producible from the polycarbonates containing COOH end groups according to the invention and the above-described further polymers. The present invention further provides such copolymers.

Production of such block copolymers or molding compounds is preferably carried out in a process comprising the steps of:
a) melting a composition containing
a polycarbonate (II) according to the invention, wherein component B is present and
a further polymer containing structural units derived from a further polymer containing at least one type of functional groups selected from ester, hydroxy and epoxy groups,
preferably containing epoxy groups, preferably a vinyl (co)polymer or polyolefin containing glycidyl methacrylate-derived structural units grafted onto the vinyl (co)polymer or polyolefin or incorporated into the polymer chain of the vinyl (co)polymer or polyolefin,
through introduction of thermal energy and/or mechanical shear,
b) mixing and dispersing the different components of the composition with/into one another,
c) solidifying the melt by cooling,
d) pelletizing the solidified product resulting from steps (a) to (c),
wherein in the context of the process a chemical coupling reaction of the structural units having a free COOH functionality derived from a hydroxybenzoic acid and present as end groups in the polycarbonate (II) with the epoxy-containing polymer is effected in the melt.

Step (b) in this process is preferably carried out in a compounding machine selected from the group consisting of single-screw extruders, co-rotating or counter-rotating twin-screw extruders, planetary roller extruders, internal kneaders or co-kneaders and likewise preferably at a temperature of the melt of 230° C. to 300° C.

### Further Components for Producing a Thermoplastic Molding Compound

The polycarbonates according to the invention containing COOH end groups, inventive thermoplastic compounds containing such polycarbonates and also inventive copolymers produced from such polycarbonates or molding compounds and inventive molding compounds containing such copolymers may be employed as a constituent of a thermoplastic molding compound, preferably containing one or more further polymers. The copolymers according to the invention and molding compounds according to the invention containing such copolymers are suitable especially as a constituent in thermoplastic molding compounds containing polycarbonate, preferably aromatic polycarbonate, as a further polymer. The inventive copolymers and inventive molding compounds containing such copolymers are further suitable as a constituent in thermoplastic polymer blend molding compounds containing aromatic polycarbonate and at least one further polymer having similar polarity to the polymer block which is bonded to the polycarbonate block in the copolymer. These copolymers and inventive molding compounds containing such copolymers are most preferably suitable as a constituent in thermoplastic polymer blend molding compounds containing aromatic polycarbonate and as a further polymer the same polymer that is bonded to the inventive polycarbonate as a polymer block in the block copolymer.

These molding compounds may contain further components such as polymer additives, processing auxiliaries and/or further polymeric components preferably selected from the group consisting of flame retardants, anti-drip agents, flame retardant synergists, smoke inhibitors, lubricants and demolding agents, nucleating agents, polymeric and nonpolymeric antistats, conductivity additives, stabilizers (for example hydrolysis, heat aging and UV stabilizers and also transesterification inhibitors), flow promoters, impact modifiers (either with or without a core-shell structure), polymeric blend partners, fillers and reinforcers and dyes and pigments.

Preferred polymeric blend partners are aromatic polycarbonate free from COOH end groups, polyesters (for example and preferably polyethylene terephthalate and polybutylene terephthalate), vinyl (co)polymers and polyolefins. These need not contain any functional groups, in contrast to the polymers used for producing copolymers. Suitable polymeric blend partners thus also include for example polystyrene, polyolefins, copolymers of ethylene and/or propylene and acrylates, styrene-acrylonitrile copolymer, styrene-methyl methacrylate copolymer and polymethyl methacrylate. These may be either rubber-free or rubber-containing. The latter applies for example to acrylonitrile-butadiene-styrene (ABS) or acrylonitrile-butyl acrylate-styrene (ASA) polymers.

The abovementioned further components are employed in a total proportion of 0% to 40% by weight, preferably 0.1% to 30% by weight, more preferably 0.2% to 20% by weight, based on the thermoplastic composition.

To achieve transparent thermoplastic molding compounds it is generally advantageous/technically necessary to eschew in their compositions certain further components such as for example fillers and reinforcers, impact modifiers and rubber-containing blend partners or to limit their concentration and the concentration of the otherwise employed further components to markedly lower contents than specified above.

Production of Molding Compounds Containing the Polycarbonates and/or Copolymers According to the Invention and Production of Shaped Articles from Such Molding Compounds

The thermoplastic molding compounds according to the invention may for example be produced by mixing together the respective constituents, i.e. the inventive polycarbonate or an inventive thermoplastic compound containing such an inventive polycarbonate and/or the inventive copolymer or the inventive thermoplastic molding compound containing such a copolymer and further polymeric components, polymer additives and/or process auxiliaries (i.e. the composition), in the melt at temperatures of 220° C. to 320° C., preferably 230° C. to 300° C., particularly preferably 240° C. to 290° C., most preferably 250° C. to 280° C.

Mixing may be carried out in customary apparatuses, for example in single-screw extruders, co-rotating or counter-rotating twin-screw extruders, planetary roller extruders, internal kneaders or continuous or discontinuous co-kneaders. The compositions are melt-compounded or melt-extruded therein to form molding compounds. In the context of the present application, this process is generally referred to as compounding or melt compounding. The term “molding compound” is thus to be understood as meaning the product obtained when the constituents of the composition are melt-compounded.

The mixing of the individual constituents of the compositions may be carried out in a known manner, either successively or simultaneously, either at about 20° C. (room temperature) or at a higher temperature. This means that, for example, some of the constituents may be introduced completely or partially via the main intake of an extruder and the remaining constituents may be introduced completely or partially later in the compounding process via a side extruder.

The molding compounds of the invention may be used to produce shaped articles of any kind. These may be produced for example by injection molding, extrusion, and blow-molding processes. A further form of processing is the production of shaped articles by thermoforming from previously produced sheets or films.

It is also possible to meter the constituents of the composition directly into the conveying extruder of an injection molding machine, to thus produce the molding compound according to the invention in the conveying extruder and to effect direct processing into shaped articles by appropriate discharging of the molding compound into an injection mold (compounding or reactive compounding injection molding).

The present invention further relates to the use of a composition according to the invention or of a molding compound according to the invention for producing shaped articles and furthermore also to a shaped article obtainable from a composition according to the invention or from a molding compound according to the invention or containing such a molding compound.

Examples of such shaped articles are films, profiles, housing parts of any type, for example for domestic appliances such as juice presses, coffee machines, mixers; for office machinery such as monitors, flatscreens, notebooks, printers, copiers; sheets, pipes, electrical installation ducts, windows, doors and other profiles for the construction sector (internal fitout and external applications), and also electrical and electronic components such as switches, plugs and sockets, and component parts for commercial vehicles, in particular for the automotive sector. The compositions and molding compounds according to the invention are also suitable for producing the following shaped articles or molded parts: internal fitout parts for rail vehicles, ships, aircraft, buses and other motor vehicles, bodywork components for motor vehicles, housings of electrical equipment containing small transformers, housings for equipment for the processing and transmission of information, housings and facings for medical equipment, massage equipment and housings therefor, toy vehicles for children, sheetlike wall elements, housings for safety equipment, thermally insulated transport containers, molded parts for sanitation and bath equipment, protective grilles for ventilation openings and housings for garden equipment.

Further embodiments of the present invention are listed below.
1. Polycarbonate containing structural units derived from bisphenol A and
   A) structural units having a free COOH functionality derived from a hydroxybenzoic acid and present as end groups and
   B) optionally structural units derived from a hydroxybenzoic acid,
      wherein component B) is selected from at least one representative of
      B1) structural units having an esterified COOH functionality derived from a hydroxybenzoic acid and present as end groups
      and
      B2) structural units derived from a hydroxybenzoic acid which are incorporated in the polymer chain via an ester or acid anhydride group,
      wherein the content of free bisphenol A in the polycarbonate is not more than 50 ppm and
      wherein in the case that component B is present the ratio of the molar amount of component B1 to the sum of the molar amounts of components A and B is not more than 0.07.
2. Polycarbonate according to embodiment 1, wherein component B is present.
3. Polycarbonate according to either of the preceding embodiments, wherein component B2 is present and the ratio of the molar amount of component B2 to the sum of the molar amounts of components A and B2 is 0.001 to 0.25.
4. Polycarbonate according to any of the preceding embodiments, wherein component B2 is present and the ratio of the molar amount of component B2 to the sum of the molar amounts of components A and B2 is not more than 0.12.
5. Polycarbonate according to any of the preceding embodiments, wherein component B2 is present and the ratio of the molar amount of component B2 to the sum of the molar amounts of components A and B2 is not more than 0.08.
6. Polycarbonate according to any of the preceding embodiments, wherein component B2 is present and the ratio of the molar amount of component B2 to the sum of the molar amounts of components A and B2 is not more than 0.03.
7. Polycarbonate according to any of the preceding embodiments 2 bis 6, wherein the ratio of the molar amount of component A to the molar amount of component B is at least 8.
8. Polycarbonate according to any of the preceding embodiments 2 bis 7, wherein the ratio of the molar amount of component A to the molar amount of component B is at least 12.
9. Polycarbonate according to any of the preceding embodiments 2 bis 8, wherein the ratio of the molar amount of component A to the molar amount of component B is at least 25.
10. Polycarbonate according to any one of the preceding embodiments, further containing
   C) structural units which are derived from at least one phenolic compound having only one phenolic OH functionality and containing no carboxy or carboxy derivative functionality and are present as end groups,
   characterized in that component C is present in the polycarbonate in a molar proportion, based on a total of 100 mol % of the molar proportions of components A, B1, B2 and C, of 50 to 90 mol %.
11. Polycarbonate according to embodiment 10, wherein component C is present in the polycarbonate in a molar proportion, based on a total of 100 mol % of the molar proportions of components A, B1, B2 and C, of 65 to 75 mol %.
12. Polycarbonate according to any of the preceding embodiments, wherein the polycarbonate is characterized by an acid number in the range from 0.3 to 30 mg potassium hydroxide (KOH)/g, determined in dichloromethane (DCM)/ethanol as solvent according to DIN EN ISO 2114, method A, 2002-6 version, by potentiometric titration with ethanolic KOH solution at room temperature.
13. Polycarbonate according to embodiment 12, wherein the acid number is 1.0 to 10 mg potassium hydroxide (KOH)/g.
14. Polycarbonate according to any of the preceding embodiments, wherein the ratio of the molar amount of component B1 to the sum of the molar amounts of components A and B is not more than 0.05.
15. Polycarbonate according to any of the preceding embodiments, wherein the ratio of the molar amount of component B1 to the sum of the molar amounts of components A and B is not more than 0.01.
16. Polycarbonate according to any of the preceding embodiments, wherein the content of free bisphenol A in the polycarbonate is not more than 20 ppm.
17. Polycarbonate according to any of the preceding embodiments, wherein the content of free bisphenol A in the polycarbonate is not more than 10 ppm.
18. Process for producing a polycarbonate (II) containing end groups having a free COOH functionality derived from a hydroxybenzoic acid, wherein
   a polycarbonate (I) containing end groups derived from a hydroxybenzoic ester
   is subjected in the presence of 0.01% to 0.30% by weight, based on the amount of polycarbonate (I), of phosphorous acid H₃PO₃
   and with application of negative pressure for 10 s to 15 min
   to a temperature in the range from 240° C. to 360° C.
to form the polycarbonate (II).
19. Process according to embodiment 18, wherein polycarbonate (I) and polycarbonate (II) contain structural units derived from bisphenol A.
20. Process according to either of embodiments 18 or 19, wherein in a preceding step the polycarbonate (I) is produced by phosgenation in the phase interface process or in organic solution of bisphenol A or a mixture of two or more structurally distinct diols containing bisphenol A in the presence of at least one ester of a hydroxybenzoic acid or a mixture containing at least one ester of a hydroxybenzoic acid and at least one phenolic compound having only one phenolic OH functionality and containing no carboxy or carboxy derivative functionality
   as a chain terminator or chain terminator mixture
and wherein the at least one ester of a hydroxybenzoic acid is an ester of a hydroxybenzoic acid esterified with an alcohol of general structural formula (1)

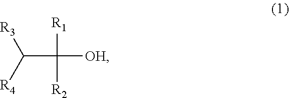

wherein R₁ to R₄ independently of one another represent hydrogen or an alkyl, aryl or alkylaryl radical having 1 to 10 carbon atoms.
21. Process according to embodiment 20, wherein directly after production of the polycarbonate (I) in a further process step which precedes the formation of polycarbonate (II) solvents which were used in the production of the polycarbonate (I) are removed down to a residual content of <0.1% by weight.
22. Process according to embodiment 21, wherein the removal of the solvent is effected either by precipitation, optional separation of the precipitated solid from the mother liquor, optional washing of the precipitated solid and drying or alternatively by spray drying and wherein the polycarbonate (I) is at no point in this upstream workup process step subjected to a temperature >200° C.
23. Process according to embodiment 20, wherein solvents employed in the production of the polycarbonate (I) are removed down to a residual content of <0.1% by weight and the formation of polycarbonate (II) is effected in a single reaction step.
24. Process according to any of embodiments 18 to 23, wherein an alkene is eliminated during production of polycarbonate (II) from polycarbonate (I).
25. Process according to any of embodiments 18 to 24, wherein the phosphorous acid is employed as an aqueous solution.
26. Process according to any of embodiments 18 to 25, wherein the production of polycarbonate (II) from polycarbonate (I) is performed in a process apparatus selected from the group comprising single-screw extruders, co-rotating or counter-rotating twin-screw extruders, planetary roller extruders, continuous or discontinuous internal kneaders, filmtruders, extruder evaporators and foam evaporators.
27. Process according to any of embodiments 18 to 26, wherein the amount of the phosphorous acid is 0.02% to 0.15% by weight based on the amount of polycarbonate (I).
28. Process according to any of embodiments 18 to 26, wherein the amount of the phosphorous acid is 0.03% to 0.07% by weight based on the amount of polycarbonate (I).
29. Thermoplastic compound containing a polycarbonate according to any of embodiments 1 to 17 and at least one phosphorus compound selected from the group consisting of phosphorous acid, phosphoric acid, salts of phosphorous acid and phosphoric acid and condensates of phosphorous acid and phosphoric acid in a total amount of 0.01% to 0.30% by weight.
30. Thermoplastic compound according to embodiment 29, wherein the phosphorus compound is selected from the group consisting of phosphorous acid and salts of phosphorous acid.
31. Thermoplastic compound according to embodiment 29 or 30, wherein the amount of the phosphorus compound is 0.02% to 0.15% by weight.
32. Thermoplastic compound according to embodiment 29 or 30, wherein the amount of the phosphorus compound is 0.03% to 0.07% by weight.
33. Copolymer containing structural units derived from a polycarbonate according to any of embodiments 2 to 17 and containing structural units derived from a further polymer containing at least one type of functional groups selected from ester, hydroxy and epoxy groups, preferably containing epoxy groups.
34. Thermoplastic molding compound containing a copolymer according to embodiment 33 and/or a polycarbonate according to any of embodiments 2 to 17 and/or a thermoplastic compound according to any of embodiments 29 to 32.
35. Use of a polycarbonate according to any of embodiments 2 to 17 or a thermoplastic compound according to any of embodiments 29 to 32 for producing a copolymer containing at least one polycarbonate block containing structural units derived from bisphenol A and at least one block of a polymer distinct from such a polycarbonate or for producing a thermoplastic compound containing such a copolymer, in a process comprising the steps of
a) melting a composition containing
a polycarbonate according to any of embodiments 2 to 17 or a thermoplastic compound according to any of embodiments 29 to 32 and
a further polymer containing at least one type of functional group selected from ester, hydroxy, and epoxy groups, preferably containing epoxy groups
through introduction of thermal energy and/or mechanical shear,
b) mixing and dispersing the different components of the composition with/into one another,
c) solidifying the melt by cooling,
d) optionally pelletizing the solidified product resulting from steps (a) to (c),
wherein in the context of the process a chemical coupling reaction of the structural units having a free COOH functionality derived from a hydroxybenzoic acid and present as end groups in the polycarbonate (II) with the further polymer containing at least one type of functional groups selected from ester, hydroxy and epoxy groups, preferably containing epoxy groups is effected in the melt.
36. Use according to embodiment 35, wherein the polymer containing epoxy groups is a vinyl (co)polymer or polyolefin containing structural units derived from glycidyl methacrylate grafted onto the vinyl (co)polymer or polyolefin or incorporated into the polymer chain of the vinyl (co)polymer or polyolefin.
37. Use according to either of embodiments 35 or 36, wherein step b) is carried out in a compounding machine selected from the group consisting of single-screw extruders, co-rotating or counter-rotating twin-screw extruders, planetary roller extruders, internal kneaders or co-kneaders and at a temperature of the melt of 230° C. to 300° C.
38. Shaped articles containing a polycarbonate according to any of embodiments 2 to 17 and/or a copolymer according to embodiment 33.

### EXAMPLES

### Production of the Polycarbonate Precursor PC (I)

Bisphenol A was subjected to the polycondensation reaction with phosgene in the presence of a chain terminator mixture consisting of p-tert-butylphenol and tert-butyl 4-hydroxybenzoate in a mixture of methylene chloride and chlorobenzene as solvent in the interfacial process in a continuously operated laboratory reactor.

In the context of this synthesis 71.9 g/h of gaseous phosgene were dissolved in 940.6 g/h of organic solvent mixture composed of 50% by weight methylene chloride and 50% by weight chlorobenzene at −7° C. The thus-produced phosgene solution was contacted with 895.8 g/h of a 15% by weight aqueous alkaline bisphenol A solution temperature-controlled to 30° C. To this end the alkaline bisphenol A solution was pressed through a stainless steel filter having a pore size of 90 μm into the phosgene solution and thus dispersed therein. The bisphenol A solution employed 2 mol of NaOH per 1 mol of bisphenol A. The reaction mixture was reacted until complete reaction of the phosgene in a Fink HMR040 mixing pump temperature-controlled to 25° C. Thereafter, 5.9 g/h of a mixture of 50 mol % of p-tert-butylphenol and 50 mol % tert-butyl-4-hydroxybenzoate were added as chain terminator, namely in the form of a 10% by weight solution in the solvent mixture composed of 50% by weight methylene chloride and 50% by weight chlorobenzene. The thus-obtained reaction mixture was further reacted with 66.0 g/h of 32.2% by weight aqueous sodium hydroxide solution in a second Fink HMR040 mixing pump temperature-controlled to 25° C. Downstream thereof were two stirred tanks run in flooded mode and fitted with baffles, each with a 600 second residence time and each followed by a respective gear pump, said pumps serving for both conveying of the reaction mixture and for further dispersing. After the first pump, i.e. upstream of the second stirred tank, 0.666 g/h of a 10% by weight solution of N-ethylpiperidine in chlorobenzene were added as catalyst. At the end of the reaction the pH was about 11.5. In a phase separation vessel the organic phase was separated from the aqueous phase of the biphasic reaction mixture and the organic phase was washed with a 0.1% by weight aqueous HCl solution to remove the catalyst. This was further followed by washing with demineralized water to remove the salt residues. The polymer solution washed in this way was precipitated in organic solvent and dried overnight in a vacuum oven at 120° C.

The thus-produced polycarbonate PC (I) is a powder and has a weight-average molecular weight M. of 18.8 kg/mol and a number-average molecular weight M. of 11.3 kg/mol measured by gel permeation chromatography (GPC) in methylene chloride as solvent at room temperature with a calibration against a bisphenol A-based polycarbonate standard and with a polycarbonate-selective infrared (IR) detector set to a wavenumber of 1775 cm⁻¹.

The content of free bisphenol A in the polycarbonate PC (I) was determined with a value of 3 ppmw.

### Production of Inventive Polycarbonates (II) by End Group Pyrolysis of the Polycarbonate Precursor PC (I)

Liberation of the COOH end groups by thermal end group pyrolysis of the polycarbonate precursor PC (I) produced according to the above-described process through elimination of the protective group in the form of isobutylene gas was carried out in a continuous Process 11 twin-screw extruder (Thermofischer Scientific, Karlsruhe, Germany) with a screw configuration having three mixing zones and a length to diameter (L/D) ratio of 40. The different inventive examples and comparative examples were produced at different melt temperatures in the range from 245° C. to 320° C., measured via a thermocouple installed close to the die outlet in the last barrel element of the extruder. The melt temperature resulted from introduction of mechanical energy through the kneading elements and introduction of thermal energy through the heating of the extruder barrel. The extruder barrel is divided into eight separate and separately heatable zones which are numbered in ascending order with the numerals 1 to 8 when viewed from the extruder inlet in the direction of the outlet die of the extruder. The three kneading zones were in the transition between heating zones 3 and 4, in the heating zone 5 and in the transition between heating zones 6 and 7. The raw material intake was in heating zone 1. The outlet die was moreover heated separately. To adjust the different melt temperatures which were detected via the thermocouple installed close to the die outlet in the last barrel element of the extruder the barrel temperatures in the barrel zones and the die temperature were temperature-controlled to different temperatures. The first barrel (raw material intake zone) was in all cases unheated, zone 2 was in all cases heated to a target temperature of 70° C., zone 3 was in all cases heated to a target temperature of 190° C. and zones 4 to 8 and the outlet die were in all cases heated to the same respective target temperature (T_{target}) according to table 1. In all cases the same polycarbonate precursor (PC (I)) was used as the input raw material. In all cases the extruder was operated with a throughput of about 300 g/h and at a speed of 175 min⁻¹. By applying a negative pressure of at least −800 mbar the isobutylene gas liberated in the extruder under these process conditions was continuously withdrawn from the extruder via a vent dome in the penultimate (seventh) heating zone. These process conditions resulted in all cases in a residence time of the polycarbonate in the extruder of about 70 s.

The addition of phosphorous acid was effected in the form of aqueous solutions by application to the powder of the polycarbonate precursor PC (I). By applying in each case 2.5 parts by weight of aqueous H₃PO₃ solution to the powder of the polycarbonate precursor PC-1, powder mixtures having different contents of H₃PO₃ were produced by using different concentrations of the aqueous H₃PO₃ solution. Production of PC powder mixtures containing 0.002% by weight, 0.01% by weight, 0.05% by weight and 0.25% by weight of phosphorous acid employed aqueous H₃PO₃ solutions having concentrations of 0.08% by weight, 0.4% by weight, 2.0/6 by weight or 10% by weight of H₃PO₃. These were uniformly applied to 99.998% by weight, 99.99% by weight, 99.95% by weight and 99.75% by weight of the powder of the polycarbonate precursor PC (I) and the mixture was then thoroughly homogenized. Due to the application of the phosphorous acid as diluted aqueous solutions this process introduced water into the polycarbonate in approximately equal quantities (2.25% to 2.5% by weight depending on the composition). The thus-produced powder mixture was either employed for the end-group pyrolysis without further drying or first dried in a vacuum drying cabinet for two hours at 100° C. to remove the water introduced via the aqueous H₃PO₃ solution from the composition before thermal treatment.

The process parameters set or measured for the differently produced inventive polycarbonates and comparative polycarbonates (set target temperatures in the extruder heating zones and at the melt outlet die, the melt temperatures measured at the temperature sensor installed close to the die outlet in the last barrel element of the extruder, the amounts of phosphorous acid added in the end group pyrolysis and information relating to any drying of the polycarbonate after addition of the aqueous H₃PO₃ solution and before the end group pyrolysis) are reported in table 1.

### Characterization of the Polycarbonates

The structural analysis of the polycarbonates in respect of the content of structural units according to components A, B1, B2-a, B2-b and C was carried out by ¹H NMR spectroscopy in deuterated chloroform as solvent at room temperature using a Bruker Avance III HD 600 MHz NMR spectrometer.

The integrated signal intensity of the respective NMR signals divided by the number of protons responsible for the signal is proportional to the molar content of the respective structural unit. The corresponding ratios of the thus-normalized signal intensities were thus used to determine the molar ratios of the corresponding structural units according to the various features for the inventive polycarbonates. Both the measured intensities of the NMR signals specific for the different structural units according to components A, B1, B2-a, B2-b and C and the molar ratios A/B, B2/(A+B2), B1/(A+B) and C/(A+B+C) determined therefrom as described above according to the characteristic structural features of the polycarbonates are also likewise reported in table 1. B2 is the sum of B2-a and B2-b and B is the sum of B1 and B2.

The content of phenolic OH groups was likewise determined from the ¹H NMR spectrum. To this end the doublet signal at about 6.68 ppm, measured relative to the reference trimethylsilane (TMS), which may be assigned to the two aromatic protons ortho to the phenolic OH group was evaluated and related relative to the singlet signal at about 1.68 ppm, measured relative to the reference trimethylsilane (TMS), which may be assigned to the six methyl protons in the bisphenol A-derived structural units of the polycarbonate backbone (of the polycarbonate polymer chain).

To determine the content of free bisphenol A the inventive polycarbonates, the noninventive polycarbonates and also the starting polycarbonate PC(I) were dissolved in dichloromethane and precipitated with acetone. The filtrate was analyzed by high-pressure liquid chromatography with a UV detector (HPLC-UV). A C18 phase was used as the column material and water and methanol in a gradient were used as eluent.

The acid number of the polycarbonates was determined in dichloromethane (DCM)/ethanol as solvent according to DIN EN ISO 2114, method A, 2002-6 version, by potentiometric titration with ethanolic KOH solution at room temperature. To this end the polycarbonate to be investigated was dissolved in a concentration of 10 g/L in 50 mL of dichloromethane at room temperature. 5 mL of ethanol were added to the sample solution before the potentiometric titration with 0.1 N ethanolic KOH.

The intrinsic color of the polycarbonate pellet materials obtained as a product of the end group pyrolysis extruder process was visually assessed on the relative color coordinate- and color intensity-based scale, as defined below, wherein an evaluation of 3 represents the best evaluation and an evaluation of 0 represents the worst evaluation:
3 colorless
2 slightly yellowish
1 yellowish
0 yellow/brownish or grayish

The phenolic OH group contents, the contents of free bisphenol A, the acid numbers and the intrinsic color of the polycarbonate pellets are also reported in table 1.

TABLE 1
Results of structural characterization and properties of produced polycarbonates

| Process | | | | | | | | | |
|---|---|---|---|---|---|---|---|---|---|
| parameters | PC-1* | PC-2* | PC-3 | PC-4* | PC-5 | PC-6* | PC-7 | PC-8* | PC-9 |
| T_{target} in | — | 250 | 250 | 260 | 260 | 280 | 280 | 300 | 300 |
| zones 4-8/ | | | | | | | | | |
| at die [° C.] | | | | | | | | | |
| Melt | — | 238 | 237 | 245 | 246 | 265 | 264 | 285 | 284 |
| temperature | | | | | | | | | |
| [° C.] | | | | | | | | | |
| H₃PO₃ [% by | — | 0 | 0.05 | 0 | 0.05 | 0 | 0.05 | 0 | 0.05 |
| wt.] | | | | | | | | | |
| Drying after | — | yes | yes | yes | yes | yes | yes | yes | yes |
| H₃PO₃ | | | | | | | | | |
| addition | | | | | | | | | |
| Feature | | | | | | | | | |
| BPA | 3 | 11 | 8 | 15 | 5 | 96 | 3 | 89 | 3 |
| [ppmw] | | | | | | | | | |
| Phenolic OH | 0.0035 | 0.021 | 0.010 | 0.044 | 0.012 | 0.10 | 0.010 | 0.10 | 0.010 |
| [% by wt.] | | | | | | | | | |
| Acid number | 0 | 3.4 | 5.1 | 2.3 | 4.4 | 0 | n.t. | 0 | 4.6 |
| [mg KOH/g] | | | | | | | | | |
| Signal | 0 | 3.0 | 4.0 | 2.2 | 4.0 | 0 | 4.1 | 0 | 4.0 |
| intensity | | | | | | | | | |
| (8.14 ppm) = | | | | | | | | | |
| A | | | | | | | | | |
| Signal | 4.3 | 0.62 | 0 | 0.47 | 0 | 0 | 0 | 0 | 0 |
| intensity | | | | | | | | | |
| (8.05 ppm) = | | | | | | | | | |
| B1 | | | | | | | | | |
| Signal | 0 | 0.25 | 0 | 0.89 | 0.14 | 3.8 | 0.06 | 3.9 | 0.09 |
| intensity | | | | | | | | | |
| (8.26 ppm) = | | | | | | | | | |
| B2-a | | | | | | | | | |
| Signal | 0 | 0.23 | 0.09 | 0.47 | 0.08 | 0 | 0.14 | 0 | 0.21 |
| intensity | | | | | | | | | |
| (8.22 ppm) = | | | | | | | | | |
| B2-b | | | | | | | | | |
| Signal | 21.0 | 20.8 | 21.4 | 21.5 | 21.5 | 21.0 | 21.5 | 20.5 | 21.7 |
| intensity | | | | | | | | | |
| (1.32 ppm) = | | | | | | | | | |
| C | | | | | | | | | |
| A/B | 0 | 2.7 | 44 | 1.2 | 18 | 0 | 21 | 0 | 13 |
| B2/(A + B2) | — | 0.14 | 0.02 | 0.38 | 0.05 | 1.00 | 0.05 | 1.00 | 0.07 |
| B1/(A + B) | 1 | 0.15 | 0 | 0.12 | 0 | 0 | 0 | 0 | 0 |
| C/(A + B + C) | 0.52 | 0.53 | 0.54 | 0.54 | 0.53 | 0.55 | 0.53 | 0.54 | 0.53 |
| Intrinsic | — | 1 | 3 | 1 | 3 | 1 | 3 | 0 | 3 |
| color of the | | | | | | | | | |
| pellet | | | | | | | | | |
| material | | | | | | | | | |

| Process | | | | | | |
|---|---|---|---|---|---|---|
| parameters | PC-10 | PC-11 | PC-12 | PC-13* | PC-14 | PC-15 |
| T_{target} in | 320 | 320 | 320 | 320 | 320 | 340 |
| zones 4-8/ | | | | | | |
| at die [° C.] | | | | | | |
| Melt | 302 | 303 | 301 | 303 | 303 | 320 |
| temperature | | | | | | |
| [° C.] | | | | | | |
| H₃PO₃ [% by | 0.05 | 0.01 | 0.01 | 0.002 | 0.25 | 0.05 |
| wt.] | | | | | | |
| Drying after | yes | yes | no | yes | yes | yes |
| H₃PO₃ | | | | | | |
| addition | | | | | | |
| Feature | | | | | | |
| BPA | 3 | 14 | 22 | 81 | 2 | 2 |
| [ppmw] | | | | | | |
| Phenolic OH | 0.013 | 0.040 | 0.054 | 0.13 | 0.015 | 0.016 |
| [% by wt.] | | | | | | |
| Acid number | 4.2 | 3.2 | 2.6 | 0 | 5.0 | 4.2 |
| [mg KOH/g] | | | | | | |
| Signal | 3.8 | 2.8 | 2.3 | 0 | 3.9 | 3.8 |
| intensity | | | | | | |
| (8.14 ppm) = | | | | | | |
| A | | | | | | |
| Signal | 0 | 0 | 0 | 0 | 0 | 0 |
| intensity | | | | | | |
| (8.05 ppm) = | | | | | | |
| B1 | | | | | | |
| Signal | 0.14 | 0.80 | 1.15 | 3.8 | 0.21 | 0.27 |
| intensity | | | | | | |
| (8.26 ppm) = | | | | | | |
| B2-a | | | | | | |
| Signal | 0.25 | 0.38 | 0.39 | 0 | 0.22 | 0.22 |
| intensity | | | | | | |
| (8.22 ppm) = | | | | | | |
| B2-b | | | | | | |
| Signal | 21.3 | 21.9 | 22.2 | 19.2 | 22.3 | 20.9 |
| intensity | | | | | | |
| (1.32 ppm) = | | | | | | |
| C | | | | | | |
| A/B | 10 | 2.4 | 1.5 | 0 | 9 | 8 |
| B2/(A + B2) | 0.09 | 0.30 | 0.40 | 1.00 | 0.10 | 0.11 |
| B1/(A + B) | 0 | 0 | 0 | 0 | 0 | 0 |
| C/(A + B + C) | 0.53 | 0.55 | 0.56 | 0.53 | 0.53 | 0.52 |
| Intrinsic | 2 | 2 | 2 | 0 | 0 | 2 |
| color of the | | | | | | |
| pellet | | | | | | |
| material | | | | | | |

Polycarbonates marked with an * are noninventive examples.
n.t. = not tested

The examples in Table 1 show that the polycarbonates produced by the inventive process, i.e. produced with addition of H₃PO₃ in the end group pyrolysis (PC-3, PC-5, PC-7 and PC-9), exhibit the desired inventive structural features and exhibit a better (color-neutral) intrinsic color and a lower content of phenolic OH groups and especially also of free bisphenol A than the comparable polycarbonates produced by the process according to the prior art without addition of H₃PO₃ in the end group pyrolysis (PC-2*, PC-4*, PC-6* and PC-8*). The polycarbonates produced according to the inventive process are much more clearly defined in their end group structure, i.e. they have a higher content of free COOH end groups A and a lower content of the precursor end group species B1 and the transesterification species B2 which undesirably results from the COOH end groups A in a subsequent reaction following the end group pyrolysis. They therefore exhibit higher values of A/B and lower values of B1/(A+B) and B2/(A+B2).

Furthermore, the comparison of the inventive example PC-3 with the comparative example PC-2* produced analogously without addition of H₃PO₃ shows that the addition of H₃PO₃ in the end group pyrolysis step of the production process not only inhibits the transesterification of the liberated COOH end groups and the formation of free bisphenol A through thermal retrocleavage but surprisingly also catalyzes the end group pyrolysis of the tert-butyl-4-hydroxybenzoate end group species B1, with the result that the end group pyrolysis is not only possible at relatively high temperatures such as are avoidable only with difficulty in many industrially established workup, for example degassing, processes in the melt but rather a quantitatively complete end group pyrolysis is in principle also possible in the range of very low melt temperatures of below 240° C., i.e. in a process with reduced energy costs. The data altogether show that for the process of the end group pyrolysis it is for the first time possible to establish a very broad, flexibly configurable process window which allows a multiplicity of possible process modes and altogether allows for more robust processes. This results in less off-spec waste and fewer process interruptions with undesired plant downtime and cleaning time.

A comparison of the inventive example PC-9 with the likewise inventive examples PC-10 and PC-15 which were all produced in the inventive process with addition of the same amount of 0.05% by weight of H₃PO₃ shows that the inventive polycarbonates are thermally stable towards further/higher thermal stress. Despite melt temperatures in the end group pyrolysis which are respectively 18° C. and 36° C. higher than PC-9, PC-10 and PC-15 achieve very low residual contents of free BPA and phenolic OH groups and improved (more color-neutral) intrinsic colors of the product compared to the prior art. This is the case especially compared to the comparative examples PC-4*, PC-6* and PC-8* which were produced at markedly lower melt temperatures in the end group pyrolysis in the process according to the prior art without addition of H₃PO₃. Despite the elevated temperatures in the end group pyrolyses, which are able to simulate a further thermal stress for example in a downstream processing step, examples PC-10 and PC-15 continue to exhibit the inventive structural features, i.e. a high content of free COOH end groups A and a low content of transesterification species B2 undesirably formed from these end group species A in a subsequent reaction following the end group pyrolysis. Compared to the inventive example PC-15 which was produced at a melt temperature of 320° C. in the end group pyrolysis step and still contains virtually the optimal (i.e. maximum possible) concentration of free COOH end groups A, comparative example PC-6* which was produced at a melt temperature of 265° C. in the end group pyrolysis step (i.e. at a temperature which is 55° C. lower compared to PC-15) no longer comprises any free COOH end groups A, i.e. these have already undergone complete quantitative transesterification in the undesired subsequent reaction.

A comparison of the examples PC-10, PC-11, PC-13* and PC-14 shows the influence of the amount of H₃PO₃ employed in the end group pyrolysis in the range 0.002% by weight to 0.25% by weight based on the amount of polycarbonate. It is apparent that a usage amount of 0.002% by weight of H₃PO₃ (PC-13*) is insufficient but a usage amount of 0.01% by weight of H₃PO₃(PC-11) is already sufficient in the end group pyrolysis step to achieve the desired technical effects in respect of the reduction of the content of free bisphenol A and phenolic end groups, the thermal stability of the free COOH end groups A towards undesired transesterification and the realization of a color-neutral intrinsic color of the polycarbonate. At a usage amount of 0.25% by weight of H₃PO₃(PC-14) the technical effects in respect of the reduction of the content of free bisphenol A and phenolic end groups and the improvement in the thermal stability of the free COOH end groups A towards undesired transesterification are still achieved but the polycarbonate produced by the inventive process with this amount of H₃PO₃ no longer exhibits an advantageous (color neutral) intrinsic color. Accordingly, this concentration of H₃PO₃ is still to be regarded as inventive but no longer as preferred.

Furthermore, comparison of the inventive examples PC-11 and PC-12 with the comparative example PC-13* shows that the desired technical effects and structural features of the produced polycarbonate are achieved irrespective of the moistness (i.e. the water content) of the polycarbonate supplied to the end group pyrolysis step of the production process, i.e. irrespective of whether the polycarbonate is dried before the end groups pyrolysis after addition of the H₃PO₃ in the form of diluted aqueous solutions. However, comparison of inventive examples PC-11 and PC-12 also shows that it is advantageous in terms of the content of free bisphenol A to perform a pre-drying.

Production of Thermoplastic Molding Compounds Containing Copolymers from the Polycarbonates and Structural Characterization Thereof

Thermoplastic PC/PMMA molding compounds containing PC-PMMA copolymers were produced from the polycarbonates PC-2* and PC-3 by a reactive extrusion process. To this end the polycarbonates were initially ground into powder and premixed with a likewise pulverulent methyl methacrylate-glycidyl methacrylate copolymer (PMMA-GMA) in a ratio of 80% by weight of the respective polycarbonate to 20% by weight of the PMMA-GMA to afford a homogeneous powder mixture. The PMMA-GMA was a random methyl methacrylate-glycidyl methacrylate copolymer having a content of glycidyl methacrylate-derived structural units of 1.0% by weight produced by free-radical polymerization and having a weight-average molecular weight M. of 60 000 g/mol measured by gel permeation chromatography at room temperature in tetrahydrofuran as solvent against a polystyrene calibration standard. The epoxy equivalent of this PMMA-GMA copolymer was determined as 0.32% by weight in dichloromethane at room temperature according to DIN EN 1877-1 (12-2000 version).

The thermoplastic PC/PMMA molding compounds were compounded from the described powder mixtures of the polycarbonates and the random PMMA-GMA copolymer in a Process 11 continuous twin-screw extruder (Thermofischer Scientific, Karlsruhe, Germany) having a screw configuration comprising two mixing zones at a melt temperature of 260° C., a throughput of about 300 g/h, a speed of 125 min⁻¹ and an absolute pressure of 100 mbar. These conditions resulted in a residence time of about 90 seconds. After discharging through a die plate the melt strand was cooled, thus solidified and subsequently pelletized. For the compounding operations the powder mixtures of the PC and the PMMA component were metered into the feed zone of the twin-screw extruder via a volumetric metering means.

The acid number of the thus-produced thermoplastic molding compounds was again determined using the same analytical method as also used in the corresponding characterization of the polycarbonates used as raw material in the reactive extrusion. The reduction in the acid number in the reactive extrudates compared to the acid number of the employed polycarbonate weighted with the mass fraction of the polycarbonate in the reactive composition demonstrates that the COOH groups of the polycarbonate were reacted during the melt extrusion. Since the ¹H NMR signals assigned to the transesterification products at 8.22 ppm and 8.26 ppm did not increase in intensity, this observation indicates a reaction of the COOH groups in the desired nucleophilic addition reaction with the epoxy groups of the glycidyl methacrylate-derived structural units in the methyl methacrylate-glycidyl methacrylate copolymer to form a PC-PMMA copolymer.

A ¹H NMR spectrum of the thus-produced thermoplastic molding compounds was again recorded in deuterated chloroform at room temperature, wherein this analysis served to verify a chemical reaction of the epoxy groups of the glycidyl methacrylate in the random methyl methacrylate-glycidyl methacrylate copolymer to form a PC-PMMA copolymer. The characteristic ¹H-NMR signals of the protons in the unopened epoxy ring at 2.64 ppm, 2.86 ppm and 3.21 ppm, measured relative to a trimethylsilane (TMS) reference, were taken as a basis and their intensity relative to the singlet signal assigned to the three methyl group protons in the methyl methacrylate at 3.6 ppm, measured relative to a trimethylsilane (TMS) reference, was evaluated. The relative intensity of these three signals decreased relative to the physical mixture of the starting components during production of the inventive molding compounds through reactive compounding. This reaction simultaneously formed in the ¹H-NMR-spectrum a very broad and comparatively poorly resolved multiplet signal in the range of 4.45-4.55 ppm which is attributed to the bonding group formed by nucleophilic addition of carboxy groups of component A to epoxy groups of component B. The occurrence of this new signal thus demonstrates that copolymer containing blocks of the components A and B has been formed through the chemical reaction of the epoxy groups in component B.

Table 2 summarizes the analytical results obtained from the three produced thermoplastic molding compounds.

Production of Shaped Articles from Thermoplastic Molding Compounds Containing the Copolymers and Technical Evaluation Thereof

The thermoplastic PC/PMMA molding compounds produced as described above which contain PC-PMMA copolymer and were produced from the compositions according to table 2 were used to produce round plates having a diameter of 25 mm and a thickness of 2 mm at a melt temperature of 280° C. and a mold temperature of 90° C. in a Boy XS (Dr. Boy GmbH & Co. KG, Neustadt-Fernthal, Germany) laboratory injection molding machine.

The transparency and the raw hue of the shaped articles thus produced was first visually assessed. The corresponding wavelength-dependent total transmittances thereof were further determined according to DIN 5033-7 (2014) and used to calculate according to DIN EN ISO 11664-3 (2013) the transmittance value Ty(D65, 10°) with light type D65 and an observer angle of 10° and the yellowness index YI(D65, 10°). These values are likewise reported in table 2.

TABLE 2
Thermoplastic PC/PMMA molding compounds, structural features
thereof and properties of shaped articles produced therefrom

| Composition | PC/PMMA-1* | PC/PMMA-2 |
|---|---|---|
| PC-2* | 80 | |
| PC-3 | | 80 |
| PMMA-GMA | 20 | 20 |
| Properties | | |
| Transmittance Y(D65, 10°) | 35 | 77 |
| [%] | | |
| Yellowness index | 42 | 16 |
| Acid number [mg KOH/g] | 2.3 | 2.8 |
| Reduction in relative | 76 | 92 |
| intensity of epoxy ¹H NMR | | |
| signal at 3.22 ppm [%]** | | |
| Contains PC-PMMA | yes | yes |
| copolymer according to | | |
| ¹H NMR evaluation (signal | | |
| at 4.5 ppm) | | |

Polycarbonates marked with an * are noninventive examples.
**Relative intensity is to be understood as meaning the ratio of the intensities of the ¹H NMR signal assigned to the unopened epoxy groups at 3.22 ppm, measured relative to a trimethylsilane (TMS) reference, to the intensity of the NMR signal of the singlet signal assigned to the three methyl group protons in the methyl methacrylate at 3.6 ppm measured relative to a trimethylsilane (TMS) reference. The reduction in this relative intensity in the PC/PMMA examples relative to the starting raw material PMMA indicates the conversion of the epoxy groups in the reactive extrusion.

The data in table 2 show that the inventive polycarbonate PC-3 realized higher percentage conversions of the epoxy groups of the PMMA-GMA copolymer in the block copolymer-forming target reaction than the comparative polycarbonate PC-2*. The data further show that the inventive PC/PMMA molding compound PC/PMMA-2 containing copolymer produced from the inventive polycarbonate PC-3 has a higher transmittance than the comparative PC/PMMA molding compound PC/PMMA-1* produced in an analogous process with the noninventive polycarbonate PC-2*. The data in table 2 further show that PC/PMMA-2 has a lower yellowness index, i.e. an improved color neutrality, compared to PC/PMMA-1*. PC-2* differs from the inventive PC-3 only in that no phosphorous acid was added during its end group pyrolysis.

1: A polycarbonate containing structural units derived from bisphenol A and
A) structural units having a free COOH functionality derived from a hydroxybenzoic acid and present as end groups and
B) optionally structural units derived from a hydroxybenzoic acid,
wherein component B) is selected from at least one representative of
B1) structural units having an esterified COOH functionality derived from a hydroxybenzoic acid and present as end groups
and
B2) structural units derived from a hydroxybenzoic acid which are incorporated in the polymer chain via an ester or acid anhydride group,
wherein the content of free bisphenol A in the polycarbonate is not more than 50 ppm and wherein in the case that component B is present the ratio of the molar amount of component B1 to the sum of the molar amounts of components A and B is not more than 0.07.

2: The polycarbonate as claimed in claim 1, wherein component B is present.

3: The polycarbonate as claimed in claim 1, wherein component B2 is present and the ratio of the molar amount of component B2 to the sum of the molar amounts of components A and B2 is 0.001 to 0.25.

4: The polycarbonate as claimed in claim 1, wherein the ratio of the molar amount of component A to the molar amount of component B is at least 8.

5: The polycarbonate as claimed in claim 1, further containing C) structural units which are derived from at least one phenolic compound having only one phenolic OH functionality and containing no carboxy or carboxy derivative functionality and are present as end groups, wherein component C is present in the polycarbonate in a molar proportion, based on a total of 100 mol % of the molar proportions of components A, B1, B2 and C, of 50 to 90 mol %.

6: A process for producing a polycarbonate (II) containing end groups having a free COOH functionality derived from at least one hydroxybenzoic acid, wherein a polycarbonate (I) containing end groups derived from at least one hydroxybenzoic ester is subjected in the presence of 0.01% to 0.30% by weight, based on the amount of polycarbonate (I), of phosphorous acid H₃PO₃ and with application of negative pressure for 10 s to 15 min to a temperature in the range from 240° C. to 360° C. to form the polycarbonate (II).

7: The process as claimed in claim 6, wherein the polycarbonate (I) contains structural units derived from bisphenol A and wherein the polycarbonate (II) contains structural units derived from bisphenol A.

8: The process as claimed in claim 7,
wherein in a preceding step the polycarbonate (I) is produced by phosgenation in the phase interface process or in organic solution of bisphenol A or a mixture of two or more structurally distinct diols containing bisphenol A in the presence of at least one ester of a hydroxybenzoic acid or a mixture containing at least one ester of a hydroxybenzoic acid and at least one phenolic compound having only one phenolic OH functionality and containing no carboxy or carboxy derivative functionality as a chain terminator or chain terminator mixture
and wherein the at least one ester of a hydroxybenzoic acid is an ester of a hydroxybenzoic acid esterified with an alcohol of general structural formula (1) 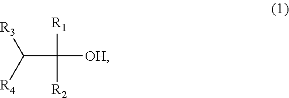
wherein R₁ to R₄ independently of one another represent hydrogen or an alkyl, aryl or alkylaryl radical having 1 to 10 carbon atoms in each case.

9: The process as claimed in claim 8,
wherein directly after production of the polycarbonate (I) in a further process step which precedes the formation of polycarbonate (II) solvents which were used in the production of the polycarbonate (I) are removed down to a residual content of <0.1% by weight
and wherein the removal of the solvent is effected either by precipitation, optional separation of the precipitated solid from the mother liquor, optional washing of the precipitated solid and drying or alternatively by spray drying
and wherein the polycarbonate (I) is at no point in this upstream workup process step subjected to a temperature >200° C.

10: The process as claimed in claim 6, wherein the production of polycarbonate (II) from polycarbonate (I) is performed in a process apparatus selected from the group comprising single-screw extruders, co-rotating or counter-rotating twin-screw extruders, planetary roller extruders, continuous or discontinuous internal kneaders, filmtruders, extruder evaporators and foam evaporators.

11: A thermoplastic compound containing a polycarbonate as claimed in claim 1 and at least one phosphorus compound selected from the group consisting of phosphorous acid, phosphoric acid, salts of phosphorous acid and phosphoric acid and condensates of phosphorous acid and phosphoric acid, wherein these phosphorus compounds are present in the thermoplastic compound in a total amount of 0.01% to 0.30% by weight.

12-13. (canceled)

14: A process for producing a copolymer containing at least one polycarbonate block containing structural units derived from bisphenol A and at least one block of a polymer distinct from such a polycarbonate or for producing a thermoplastic molding compound containing such a copolymer, in a process comprising the steps of
a) melting a composition containing the polycarbonate or the thermoplastic compound and a further polymer containing at least one type of functional groups selected from ester, hydroxy and epoxy groups, through introduction of thermal energy and/or mechanical shear,
b) mixing and dispersing the different components of the composition with/into one another,
c) solidifying the melt by cooling,
d) optionally pelletizing the solidified product resulting from steps (a) to (c),
wherein in the context of the process a chemical coupling reaction of the structural units having a free COOH functionality derived from a hydroxybenzoic acid and present as end groups in the polycarbonate (II) with the polymer containing at least one type of functional groups selected from ester, hydroxy and epoxy groups is effected in the melt.

15. (canceled)

16: A thermoplastic molding compound containing a polycarbonate as claimed in claim 2.

17: A thermoplastic molding compound containing a thermoplastic compound as claimed in claim 11.
